(19) United States
(12) Patent Application Publication
(10) Pub. No.: US 2007/0122778 A1
(43) Pub. Date: May 31, 2007

(54) Simulation and multimedia integration and navigation interface and method

(76) Inventors: Ken J. Beitel, Boulder, CO (US); Gregory Korthuis, Golden, CO (US); Brad Albrechtsen, Highlands Ranch, CO (US); Duayne M. Orner, Aurora, CO (US); Alice Palmer, Greenwood Village, CO (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/540,825

(22) Filed: Sep. 29, 2006

Related U.S. Application Data
(60) Provisional application No. 60/740,132, filed on Nov. 28, 2005.

(51) Int. Cl. G09B 19/00

(52) U.S. Cl. 434/219

(57) ABSTRACT

A method that integrates the display of simulation and multimedia by dividing software simulation into a navigable structure that can be accessed with linear and random access navigational controls. A user interface is utilized to provide simultaneous or consecutive display of interactive simulation and multimedia content within windows of standardized shape, location and size. Controls, including menu selection and forward and back buttons permit navigation through integrated multimedia pages/sections and simulation. The assignation of attributes, programmatic methods and programmatic events to navigable simulation and multimedia structural units, referred to as “tracks”, enables communication between the multimedia and simulation tracks, which maintains synchronization of the joint display. The random access navigation features of the interface permits adaptive simulation content display based on user performance, skills, needs and preferences.

### CROSS REFERENCE TO RELATED APPLICATIONS

This application claims the benefit of U.S. Provisional Patent Application No. 60/740,132, filed Nov. 28, 2005, the entirety of which is hereby incorporated by reference into this application.

### BACKGROUND OF THE INVENTION

### Field of the Invention

With the increasing power of personal computers, the ability to provide simulation based training has moved from warehouse size, full motion training devices to commercial-off-the-shelf desktop and laptop PCs. However, when large full motion simulators are used for training, an instructor is usually present to coach, guide and evaluate the student. In addition, students using large full motion simulators have normally received prior Computer Based Training (CBT) or classroom instruction to provide the background information necessary to operate an aircraft or other complex simulated device. While high fidelity simulators accurately depict real world performance, they offer a student only the opportunity to practice existing skills. Without an instructor or prior instruction, stand-alone simulations are not capable of providing new information to a student, except on a trial and error basis.

Some conventional simulation applications have offered pop-up, floating windows containing additional information for the student. This solution can be problematic because important sections of the simulation may be obscured by a pop-up window. In addition, once the pop-up has been closed, students may be unable to review the contents of the pop-up without repeating the entire simulation.

A consideration of using software simulation for training is that students must be able to efficiently navigate back and forth through all forms of educational content.

Navigation is problematic for existing simulations; currently navigation is limited to launching individual mission scenarios and being able to accelerate the flow of time. The only way to repeat a procedure when a mistake is made is to restart a mission scenario which typically takes 20 to 40 seconds. This is often disadvantageous as a student may want to review dozens or hundreds of items during a course.

Accordingly, for simulations to be an effective stand-alone training tool there is a need to present multimedia background information, such as instructional text, graphics, 5 and audio, integrated and tightly synchronized with simulation content. In addition, to be user friendly and time efficient, a user must be able to freely navigate through the combined multimedia and simulation content in a fast and intuitive manner.

### SUMMARY OF THE INVENTION

The present invention provides a user interface for the display and navigation of integrated multimedia and simulation content. Multimedia content provides background information to a user, for example, instructions on how to operate an aircraft or other complex machinery, while the simulation allows the user to safely practice normal operations and emergency procedures. The present invention allows the user to efficiently and intuitively navigate through the combined multimedia and simulation content thus facilitating rapid access to and review of training sections. The random access navigation ability also allows for automated Adaptive Simulation Training, in which the system analyzes user performance and presents appropriate educational content. The present invention is suitable for providing self-paced training. The present invention can also be used for providing instructor led simulation/multimedia training and entertainment or gaming applications.

One aspect of the present invention includes organization of a software simulation into a navigable structure comprising discrete sections. The discrete simulation sections are referred to as simulation tracks. The simulation track initializes the simulation to a pre-defined point. The simulation track sets a simulation start position including type and state of all entities, global environment attributes, a camera view and other relevant details. The simulation tracks are then able to be used as distinct segments, which can be navigated with back and forward and menu (random access) controls. Simulation tracks can have a defined end point, for example a successful aircraft landing, after which the interface could automatically end the lesson or advance to the next simulation track. Simulation tracks can also be left open ended wherein the simulation track can run until the user terminates the track, thereby allowing free-play practice opportunity.

Advantageous use is made of simulation tracks as a device for maintaining synchronized, simultaneous display of multimedia and simulation. To facilitate a parallel functional structure, the present invention organizes multimedia training, also known as Computer Based Training (CBT), into CBT tracks. As the user navigates through content, the interface maintains display of CBT tracks in synchronization with a correct simulation track. This tight integration allows the CBT track to reference specific simulation events, provide coaching and feedback on simulated procedures and to highlight controls or displays on instrument panels within the simulation.

The interface of the present invention provides standardized display areas for CBT and simulation content. In one embodiment of the invention, a CBT display window is either full screen or partial screen with the simulation running alongside. At times when CBT content is not required, the simulation can be displayed full screen. Typically a lesson starts with full screen CBT display to provide detailed background information. Thereafter, the lesson moves to a partial screen CBT display for discussing or demonstrating specific elements of a simulation running alongside the CBT display. User practice and coaching can occur using the partial screen CBT display. Once the user has received background information from the CBT display, the simulation can be displayed full screen.

CBT window size and shape appropriate for a section of content (full screen CBT display, partial screen CBT display or full screen simulation display) is displayed automatically as the user navigates back and forth through the lesson. A consistent size and location of the CBT windows provides the user with a standardized display appearance that allows the user to focus on the training content. For flexibility, the interface offers several CBT window options to allow a lesson creator to select from a range of preset locations, sizes, and shapes. In an alternative embodiment of the invention, the interface provides custom window locations, sizes and shapes which a lesson creator can select to appear over the simulation instead of running alongside.

Interface navigation options can include back, forward, replay, menu and exit controls. The back and forward controls allow users to return to previous CBT display pages, or to step back and forth through simulation tracks while practicing a procedure. The controls are intuitive and easy-to-use.

During navigation, when both the CBT and simulation are simultaneously displayed, the interface maintains correct synchronization between the two elements. A replay button can restart any animations present in a CBT display window and can refresh the simulation to a start point for the current CBT page. A menu control displays a lesson menu to permit the user to jump to different sections of the lesson, or to different lessons. Lesson creators can disable/enable controls as appropriate to provide a sequential flow for the lesson or enable menu selections only for lesson segments that have already been completed.

Communication between CBT tracks and simulation tracks allows a CBT track to reference events and demonstrations within a simulation track and vice versa. For example, opening or closing valves on a CBT display of an animated hydraulic flow diagram will close or open the same valves in the simulation. In another example, activating a hydraulic pump switch in a simulation causes flow changes on an animated CBT display of a flow diagram. In another embodiment, each time a user activates a simulation control, such as a switch or button, the CBT display displays functional information for the corresponding simulation control.

According to one aspect of the present invention, the interface of the present invention can be used for Adaptive Simulation Training. Adaptive Simulation Training is the ability to present, assign and navigate through simulation content based on user skills, needs and preferences. For example, random access navigation provided by the interface of the present invention can present a remedial simulation track titled “Loop Basic Skills” to a user who is having trouble flying a loop. Following the completion of the remedial track, the user can receive additional loop practice to ensure mastery of the procedure. In another example, a user who demonstrates rapid advancement during radar control panel training can receive accelerated instruction and be quickly moved forward to a final evaluation on that device.

According to another aspect of the invention, simulation tracks can be mapped to hierarchal task or learning objective structures. Mapping of simulation tracks to task, objective or other user defined hierarchies allows user scoring and evaluation to be cross referenced against tasks or objectives for summative evaluation, permits navigation by task/objective or can be used for other user defined purposes.

The invention will be more fully described by reference to the following drawings.

### BRIEF DESCRIPTION OF THE DRAWINGS

FIG. 1 is a schematic diagram of a Simulation Track.

FIG. 2 is a schematic diagram of a CBT Track.

FIG. 3 is a schematic diagram of a CBT Track with page navigation.

FIG. 4 is a schematic diagram of a CBT and a Simulation Track including track metadata.

FIG. 5 is a flow chart depicting the generation of CBT Tracks and simulation tracks, and their placement within a lesson structure.

FIG. 6 schematic diagram of lesson structure which provides a navigable, hierarchal grouping of simulation tracks and CBT tracks.

FIG. 7 is a schematic diagram of the interface displaying a partial screen CBT display window adjacent to a partial screen simulation window.

FIG. 8 is a schematic diagram of the interface displaying a full screen simulation window.

FIG. 9 is a schematic diagram of the interface displaying a full screen CBT display window.

FIG. 10 is a schematic diagram depicting integrated CBT tracks and Simulation tracks used in an example training lesson.

FIG. 11 is a schematic diagram of the interface including a partial screen CBT display window illustrating a range of standardized sizes and locations.

FIG. 12 is a schematic diagram of the interface including a partial screen CBT display window illustrating a range of user customizable sizes, shapes and/or locations.

FIG. 13 is a schematic diagram of the interface including a track/topic selection menu.

FIG. 14 is a flow chart depicting interface navigation using forward and back buttons.

FIG. 15 is a flow chart depicting interface navigation using replay, menu and exit buttons.

FIG. 16 is a flow chart illustrating communication between a CBT track, a simulation track and the simulation.

FIG. 17 is a high level flow chart depicting an overview of a Dynamic Syllabus which provides Adaptive Simulation Training.

FIG. 18 is a flow chart detailing functionality of the Dynamic Syllabus used to provide Remedial Adaptive Simulation Training.

FIG. 19 is a flow chart depicting a process for providing Predictive Adaptive Simulation Training.

FIG. 20 is a flow chart depicting a process for providing Continual Evaluation Adaptive Simulation Training.

FIG. 21 is a flow chart depicting the association of the CBT Tracks and Simulation Tracks with Tasks/Objectives or other user defined attributes or hierarchies.

FIG. 22 is a schematic diagram of an interface system of the present invention coupled to a host computer system.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

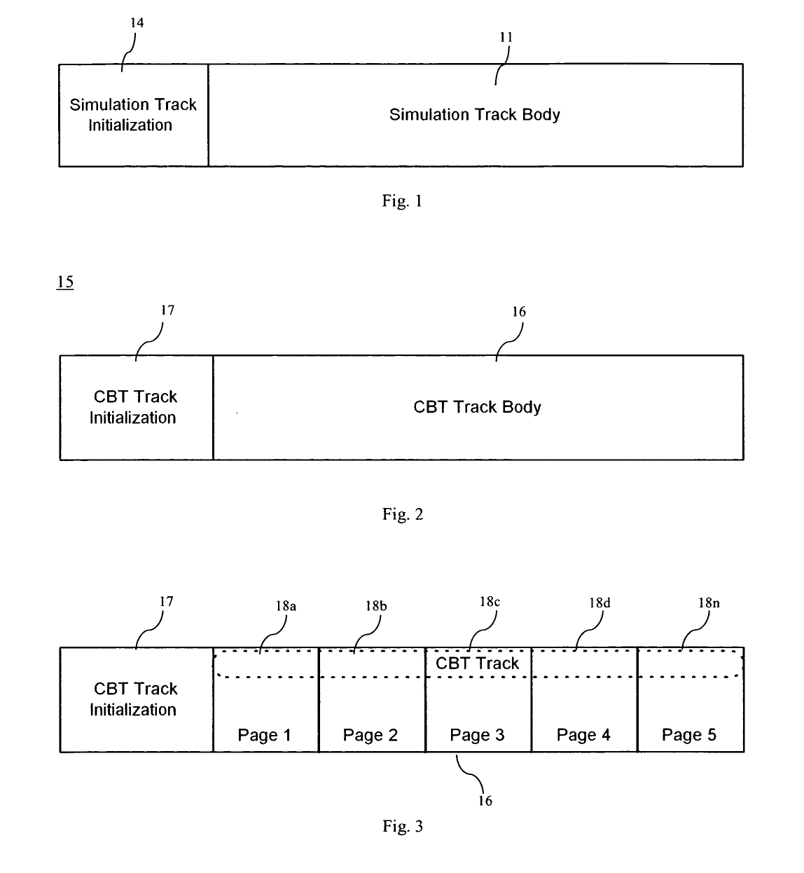

The present invention illustrated in FIGS. 1-22 provides the simulation and multimedia integration and navigation interface. In the presently described embodiment, the interface provides an integrated Computer Based Training (CBT) and simulation display with an organized navigation structure. As will be described in more detail below, in a preferred embodiment the simulation and CBT are structured in simulation tracks and CBT tracks according to track metadata, track initialization data, and a track body which operate together to describe, initialize, and create the functionality of each track.

FIG. 1 illustrates an embodiment of a base structural unit for partitioning a software simulation into a navigable structure. Simulation track 12 includes simulation track body 11 and simulation track initialization information 14. Simulation track body 11 provides guided simulation or free play training to the user. Guided simulation can include the following: demonstration of procedures, maneuvers, or instrument operation; monitoring and coaching of a user during practice of procedures or maneuvers; performance based evaluation including carrying out normal operations or emergency procedures by a user while the simulation track monitors, records, and analyzes the speed and accuracy of the user's performance; and Adaptive Simulation Training based on academic or performance based evaluation. Based on CBT test questions, exercises or performance based simulation evaluations, the present invention uses a dynamic syllabus to provide Adaptive Simulation Training to ensure users reach specified proficiency levels, as described below. A terminal objective can be provided to end the scenario, i.e., successfully land the aircraft at Dover Air Force base. Free play allows users to practice skills in specific areas or in an area selected by user.

Simulation track initialization information 14 provides simulation start point information to delineate a reference to the simulation including one or more of the following parameters: type, location and heading of one or more controlled entities, entity state information, i.e., how much fuel, engine condition, damage, failures, and the like; global environment attributes and type/state information on all other entities present in the simulation. Simulation track initialization information 14 can be stored in a text or XML file, or in a database or other digital storage device. In the preferred embodiment of the invention, simulation track initialization data 14 is stored as XML files generated by utilizing a graphical authoring tool or by performing a gold standard simulated operation and outputting simulation track initialization snapshots at logical intervals.

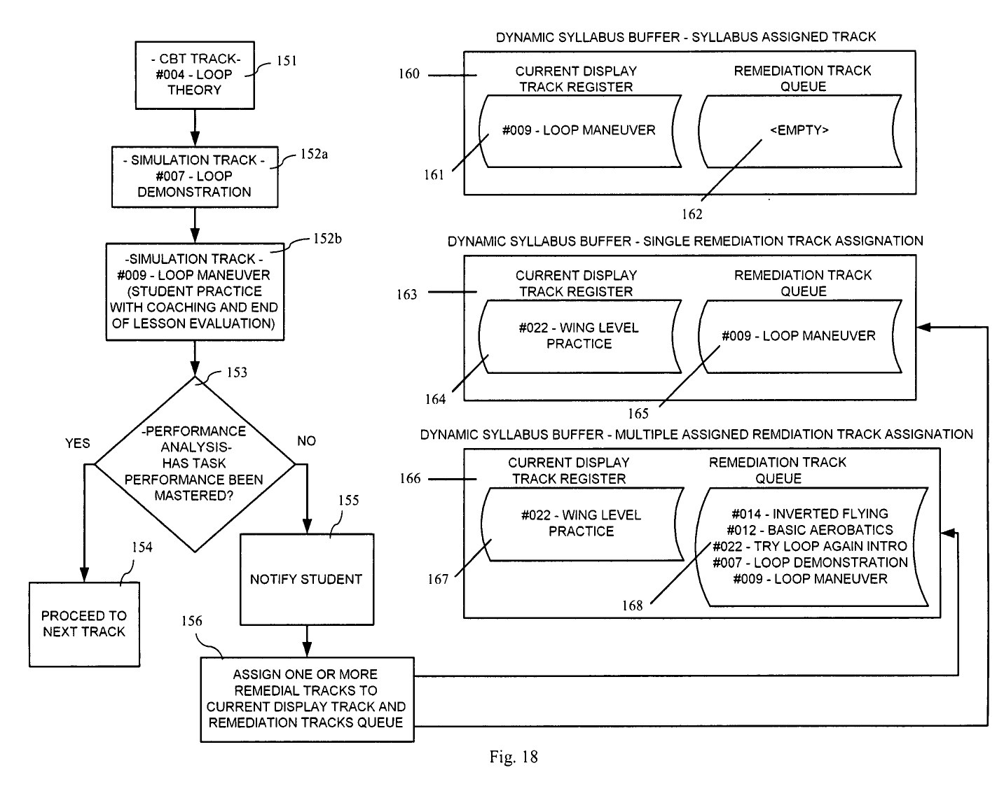

Simulation track body 11 works by executing, monitoring, branching and providing other functionality alongside an active software simulation. In the preferred embodiment of the present invention, the interface maintains a counter that contains a unique identification (ID) of the simulation track currently executing in parallel with the simulation. This counter is illustrated in FIG. 18 as the current display track register 161. When the current display track register is changed to a different simulation track ID, simulation track initialization information 14 for the new track is loaded. In an alternative embodiment of the invention, multiple simulation tracks could execute in parallel to provide additional performance monitoring and coaching.

Simulation track body 11 defines simulation track attributes, programmatic methods (software coded functions and subroutines), and programmatic events that can be raised by the track. This functionality allows the simulation track to monitor simulation and CBT track attributes and programmatic events and react to user interactions, simulation and CBT attributes/programmatic events in some of, but not limited to the following ways: display text, activate text to speech engine, engage camera moves, highlight control panels or buttons, communicate simulation attributes to CBT window, change values of simulation attributes; loop/branch including decision branching/jump to different program flows within a current simulation track or other simulation tracks; call programmatic methods in a CBT track and simulation and activate autopilot or use other techniques to demonstrate instrument operation, procedures, or maneuvers.

Simulation track body 11 can be broken down into sections or finer subdivisions (not shown). Sections and finer subdivisions of a simulation track specify which portions of the simulation track execute at a specific time; as an example, only the monitoring and actions of a first section referred to as Section 3 might be active until the first half of an aircraft loop maneuver is performed, at which point execution of the monitoring and actions of a second section referred to as Section 4 would commence. Sections and finer subdivisions of simulation tracks are uniquely identified to allow program branching to those points.

FIG. 2 illustrates an embodiment of a base structural unit for partitioning multimedia or computer based training (CBT) into structural units of CBT track 15. CBT track 15 includes CBT track body 16 and CBT tract initialization information 17.

FIG. 3 illustrates an embodiment of CBT track 15 that implements page based navigation. CBT track 15 can use page based navigation or be comprised of a single page. A page based CBT track 15 is comprised of a series of pages (18a-18n) that can be navigated through by using interface forward and back navigation controls, described below. In alternate embodiments, CBT track 15 does not use page based navigation. For example, CBT track body content can comprise a single video clip, flash animated diagram or a 3-D Director model, and the like.

CBT track body 16 provides interactive CBT content to a user. CBT track body 16 provides background information required by the user to successfully perform simulation operations or procedures; CBT tracks can also assess user academic and performance skills with evaluation questions or interactive assessment exercises. In a preferred embodiment of the invention, student assessment results from both CBT and simulation tracks are stored in a database. CBT track body 16 can display static or interactive content using text, graphics, animation, audio, video, or any other medium capable of being displayed using a computer. CBT track body 16 can provide guidance and feedback while a user performs simulation operations and the ability to navigate to discrete CBT or simulation tracks permits use of the Adaptive Simulation Training method. The Adaptive Simulation Training method includes the assignment of additional CBT or simulation tracks to a student's syllabus when required to ensure mastery of subject matter, the granting of credit for CBT or simulation tracks, prior to completion of the track, if a student is already familiar with the content delivered by the track, and the ability for a CBT or simulation track to vary its presentation in order to more effectively deliver content based on student assessments, performance, skills, needs and preferences.

In a preferred embodiment of the invention, student performance and assessment results from CBT and simulation tracks are stored in a database which permits detailed analysis and reporting of student progress and training content.

CBT track initialization information 17 can include: a unique identifier for the track and initialization data for CBT track attributes. While a lesson creator can add custom CBT track attributes as desired, standard CBT attributes exist to control the page and navigation structure of the track. Standard CBT attributes for which there is corresponding CBT track initialization information include the total number of pages in the track, and initialization data for each page including: filename/s or database location of static or interactive content to be displayed; content formatting instructions specifying details like size/location of content on page, ID of associated simulation track; size, type, and location of CBT window; and attributes that specify the initial enabled/disabled display state of navigation controls. CBT track initialization data can also include the start state of any custom CBT track attributes that have been added to a CBT track by a lesson creator.

CBT track body 16 defines CBT track attributes, programmatic methods (software coded functions and subroutines), and programmatic events that can be raised by the track. This functionality allows the CBT track to monitor simulation and simulation track attributes and programmatic events and react to user interactions, simulation and simulation track attributes/programmatic events in some of, but not limited to the following ways: display text, graphics or other multimedia content, activate text to speech engine, change size, type or location of CBT window, display any page within the current or other CBT track, change values of CBT attributes; loop/branch including decision branching/jump to different program flows within the current CBT track or other CBT tracks; call programmatic methods in a simulation track and simulation; and store user performance and assessment information in a database.

User interactions and programmatic events that occur in CBT track 15 can be communicated to simulation track 12. For example, if page 4 of track page 18d discusses an aircraft's Heads Up Display (HUD) Air Speed Indicator, when the CBT current page attribute reaches page 4, program code on page 4 of the CBT track calls a simulation track 12 programmatic method to change the camera angle to a close-up view of the HUD, then calls another simulation track 12 programmatic method to highlight the HUD Air Speed Indicator. Another example is an animated Flash hydraulic flow diagram in which a user interaction closes a hydraulic valve to close. When the user clicks on the CBT window to close the valve, the animated Flash diagram calls a CBT program code programmatic method to indicate that a specific hydraulic valve has been closed. This allows the CBT program code to set the value of the CBT track attribute representing the state of the valve to closed, which causes the associated simulation track to call a programmatic method in the simulation thereby closing the corresponding valve in the simulation.

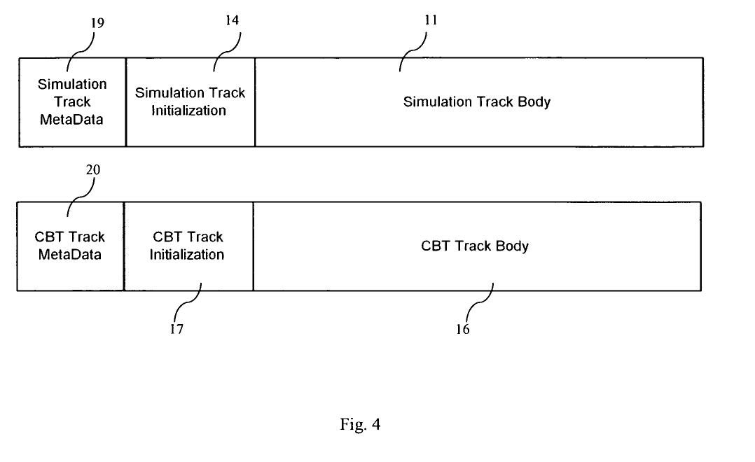

FIG. 4 depicts simulation track metadata 19 and CBT track metadata 20. Simulation track metadata 19 and CBT track metadata 20 provide information describing the track including the following parameters: unique ID number of the track being described; track title, subject keywords, ID numbers of other tracks referenced by this track, and ID number of training tasks or objectives that are taught by the track. Simulation track metadata 19 and CBT track metadata 20 can be stored in variety of formats including in an XML or .ini file or in a database. In the preferred embodiment of the invention, simulation track metadata 19 and simulation track initialization information 14 are stored in a single XML file per track; simulation track body 11 is stored as an executable code file. Similarly, CBT track metadata 20 and CBT tract initialization information 17 are stored in a single XML file per track while CBT track body 16 is stored as an executable code file. Thereafter, the interface can be initialized to a known simulation start point by simulation track 12, which then monitors and controls the simulation thus providing simulation navigation and access. Simultaneously and synchronized with the simulation track 12, the interface utilizes the CBT track 15 to provide CBT navigation and access to multimedia resources.

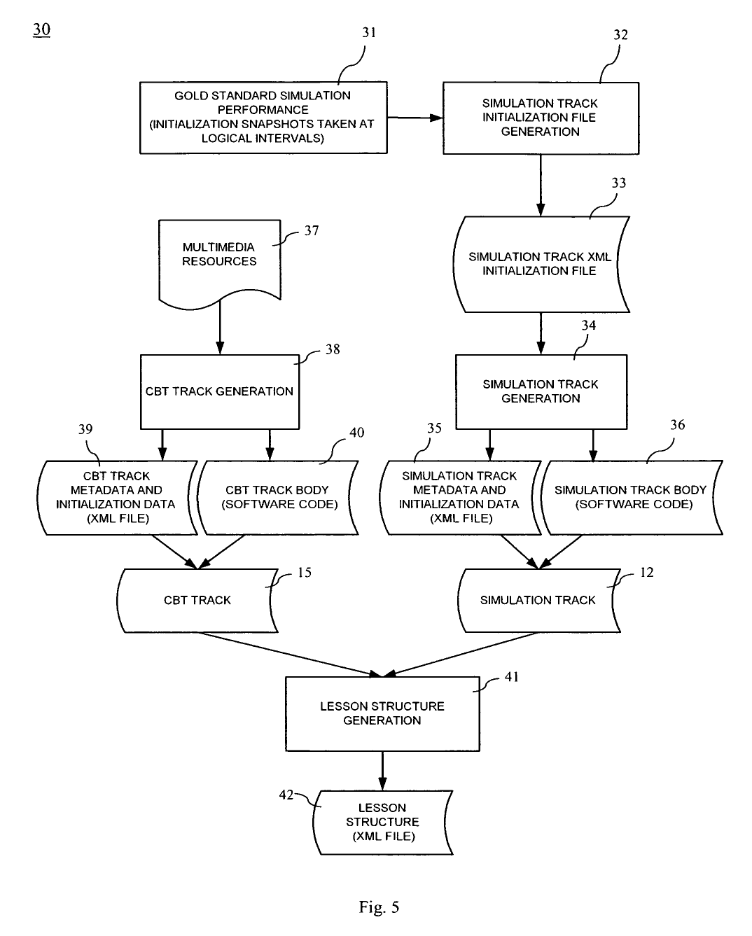

FIG. 5 is a flow chart depicting method 30 used by a graphical authoring tool to generate CBT track 15 and simulation track 12. Once generated, CBT track 15 and simulation track 12 are placed within lesson structure 42 to provide a navigable, hierarchal grouping of CBT tracks 15 and simulation tracks 12.

In the preferred embodiment of the invention, the functionality of both CBT tracks 15 and simulation tracks 12 is generated by means of metadata, initialization data and software code produced by a graphical authoring tool. Lesson creators use the graphical authoring tool to produce at least one CBT track 15 and at least one simulation track 12 by arranging flow chart like icons to create track attributes, select attributes and programmatic events to monitor, specify response actions, and construct program loops and branching. Advanced users can also use the graphical authoring tool, or add custom code, to add additional programmatic methods to the track and raise programmatic events.

When the interface interprets the XML file that contains the lesson structure 42 this causes the execution of software code that defines CBT and simulation tracks comprising the lesson. During track execution, CBT track body 40 reads its initialization files 39 to set the start state of CBT track and page attributes in order to begin content display. Simulation track body 36 uses its initialization files 35 to set the simulation to a known, specified start point, then continues to monitor and control the simulation. During lesson display, the segment and topic lesson structure is visible to the user as a hierarchal menu structure.

Alternative embodiments of the invention can use XML files, any form of software code, or other interpreted symbology, built into or run in parallel with the simulation, stored in a file or database or other means to achieve the described functionality of CBT tracks 15 and simulation tracks 12.

The graphical authoring tool provides the following functionality: CBT track generation including metadata, initialization and body; simulation track generation including metadata, initialization and body; and lesson structure generation.

During the creation and editing process, a CBT track 15 and corresponding simulation track 12 can be viewed side by side while CBT content is created, placed and/or formatted. The size, location and type of the CBT window can also be specified for each page of the CBT track. Simulation track actions and responses can be added and edited in-sync with the CBT track. For instance, the lesson creator can add a simulation track highlight to an instrument panel button that will appear when a particular CBT page is displayed or other interaction occurs with the CBT, like a click on the hyperlink name of an instrument panel button.

CBT track, simulation track and simulation attributes, which pass information between tracks and the simulation or vice versa are created or identified. Actions that are triggered by an attribute reaching or maintaining a specific value can be constructed either with the graphical authoring tool or through use of custom code for more complex interactions.

Simulation snapshots can be taken in module 31 and used to generate simulation track initialization files. Module 32, enables lesson creators to import and edit snapshot files or to create new simulation track initialization files. Output from module 32 is formatted and saved as a simulation track XML initialization file 33.

In module 34, simulation track generation is performed using the graphical authoring tool to allow a lesson creator to assign track ID, title, keywords, and other metadata attributes to the simulation track and to select a simulation track initialization file for the simulation track being created. Module 34 can also add sections to the simulation track which are simulation track subdivisions that assist in organizing logic flow as only one section executes at a specific time. During execution, simulation track 12 can branch to different sections within simulation track 12 and additional finer subdivisions of sections can be used as needed. Simulation track generation can also be used to: add simulation track attributes, programmatic methods, and programmatic events; specify which simulation and CBT track attributes and programmatic events should be monitored; specify reaction to simulation and CBT attributes and programmatic events, specify decision and looping branching for determining program flow within the current track or other tracks and activate autopilot or use other techniques to demonstrate instrument operation and procedures.

Module 34 generates two distinct output files. In the preferred embodiment of the invention, the simulation track output files are a joint XML metadata and initialization file 35, and for the simulation track body, an editable software code file 36 which is compiled prior to program execution.

In module 38, CBT track generation is performed using the graphical authoring tool to allow a lesson creator to: assign track ID, title, keywords, and other metadata attributes to a CBT track; add blank pages; and specify size, type, and location of CBT window for each page. Module 38 can also select, add and format multimedia information/resources 37 for each page; specify which navigation controls are active at page start-up; specify a simulation track ID assigned to each partial screen CBT page; create CBT attributes, programmatic methods, and programmatic events; create response actions to simulation/CBT track and simulation attributes, events, and user interactions; and specify decision and looping branching for determining program flow within the current track or other tracks.

Module 38 generates two distinct output files. In the preferred embodiment of the invention, the CBT track output files are a joint XML metadata and initialization file 39, and for the CBT track body 40, an editable software code file which is compiled prior to program execution.

In module 41, lesson structure generation is performed by the graphical authoring tool which allows a lesson creator to: generate segment names; generate topic names; assign topics to segments thereby establishing a hierarchy between segments and topics; assign tracks to topics thereby establishing a hierarchy between topics and tracks; set option as to whether individual track IDs or titles appear on a menu or just segment and topic titles and assign a segment, topic and track sequence with an optional enforcement of whether the designated sequence is optional or required. The generated segment names can be used in a top level menu item or grouping. The generated topic names can be used as a secondary level menu item or grouping.

Module 41, outputs the lesson structure file. In the preferred embodiment of the invention, the lesson structure output file is an XML file including lesson metadata and lesson data. Alternatively, a lesson structure could be stored in a database, or in any digital format.

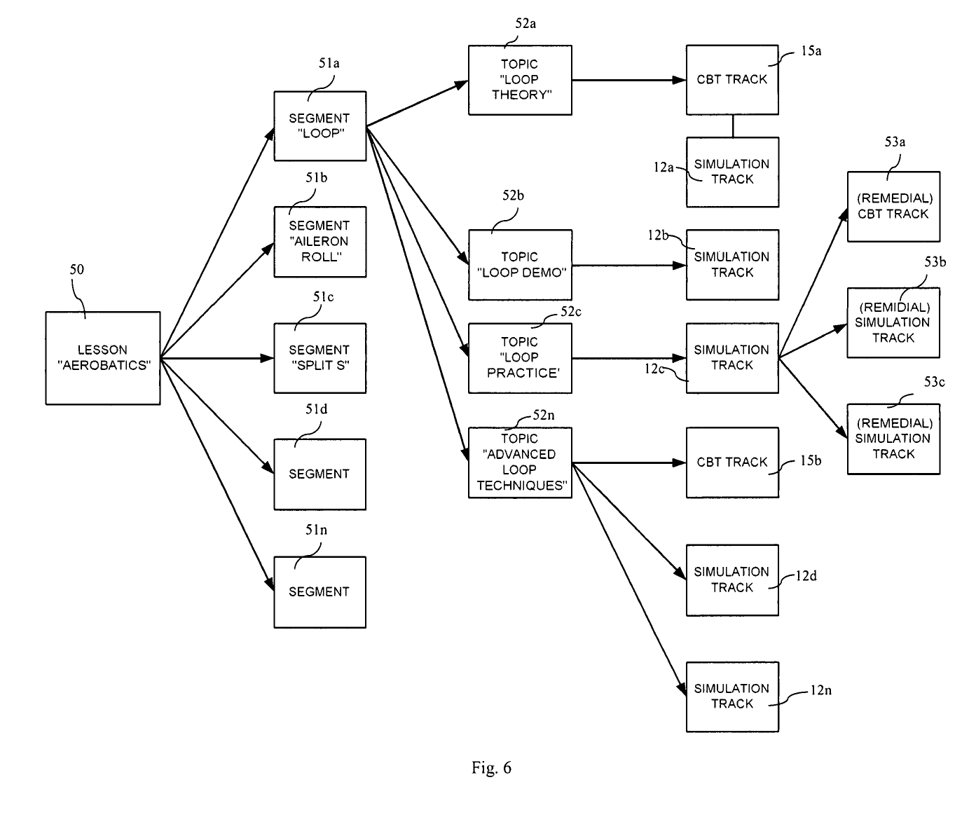

FIG. 6 is a schematic diagram of lesson structure which provides a navigable, hierarchal grouping of at least one simulation track 12 and at least one CBT track 15. In a preferred embodiment of the invention, training lesson 50 is subdivided into several high level segments 51a-1n. In this embodiment, segments 51a, the Loop segment, is expanded into topics 52a-52n. Each of topics 52a-52n displays one or more CBT tracks 15 or simulation tracks 12. For additional training, simulation track(s) 12c can refer to one or more remedial CBT 53a or simulation tracks 53b and 53c. CBT tracks 15 can also refer to remedial CBT or simulation tracks (not shown). While tracks are the content building blocks of the lessons, the hierarchy of segment, topics and tracks allows for a logical grouping of individual CBT and simulation tracks and a simplified hierarchal menu display, as described below.

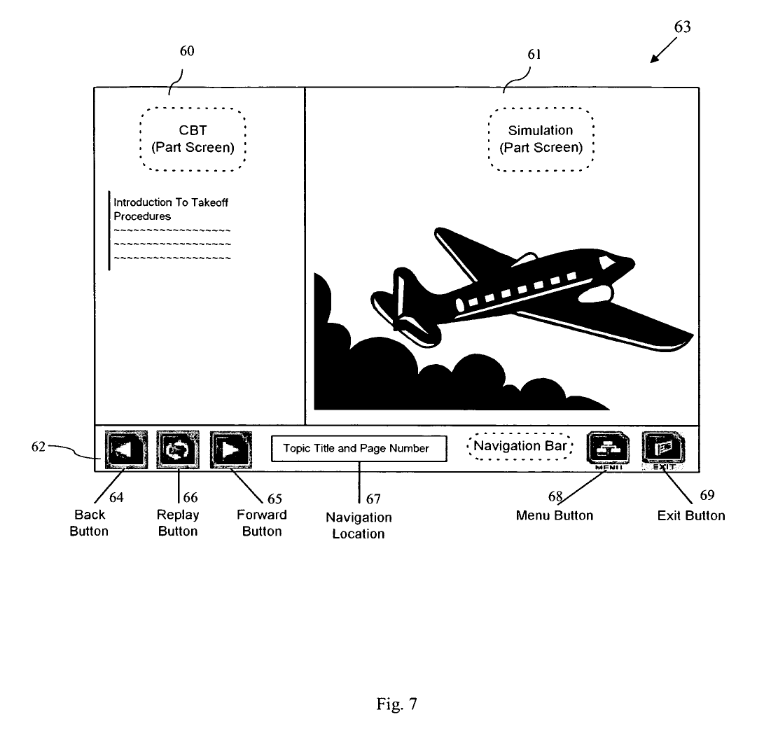

FIG. 7 is a schematic diagram of an embodiment of the interface of the present invention illustrating the use of a partial screen CBT docking window 60 alongside an active partial screen simulation window 61. Navigation controls are located on navigation bar 62 docked to the bottom of the screen 63. Back button 64 and forward button 65 allow for navigation through both CBT pages and CBT tracks 15 and simulation tracks 12. Replay button 66 restarts CBT track 15 and/or resets simulation track 12 to its initial state so an exercise can be repeated. When CBT track 15 is restarted, if the page features a partial screen display with an associated simulation track 12, simulation track 12 will be reset to an appropriate start point for the current page of the CBT track 15.

Navigation location 67 is an indicator that provides title and page information on the current lesson navigation location. In a preferred embodiment of the invention, navigation location 67 can display a topic title and a page count based on a total of the number of CBT pages in the topic plus the number of simulation tracks; under this schema, simulation tracks are counted as pages within a topic. In an alternative embodiment of the invention, navigation location 67 displays the track title and page number of the current track for CBT track 15, or the title for simulation track 12. Menu button 68 can be activated to bring up a menu to allow the user to navigate to different locations within the lesson. Exit button 69 can be activated to exit screen 63.

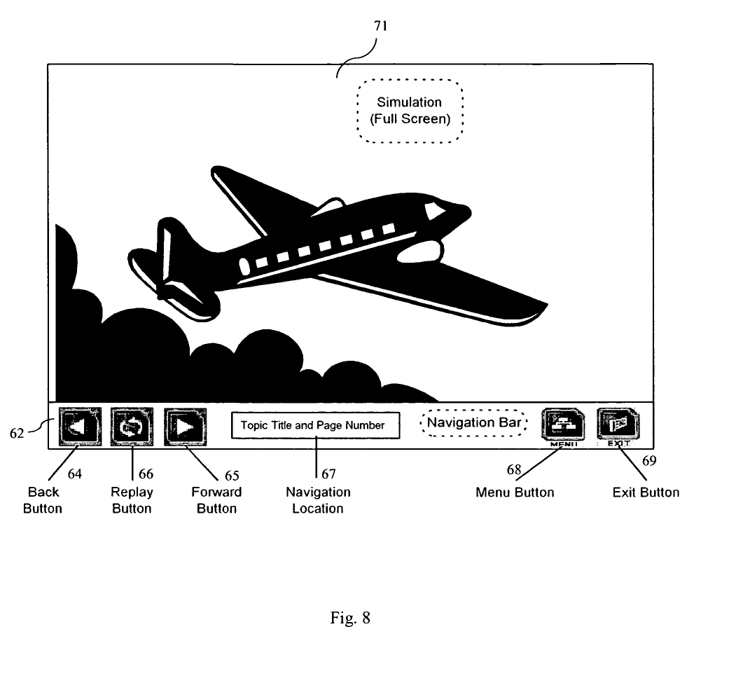

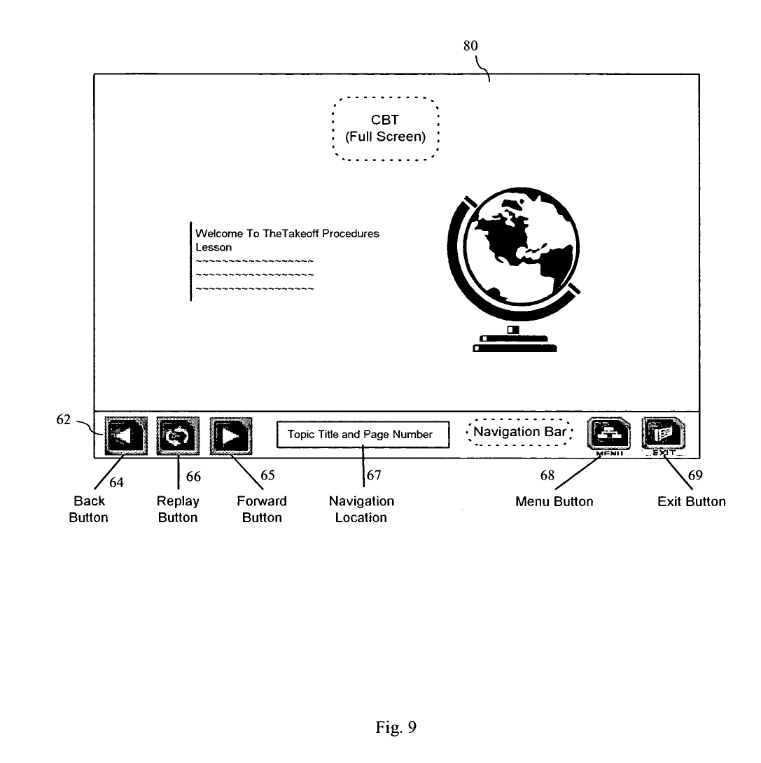

FIG. 8 is a schematic diagram of an embodiment of the interface illustrating use of full screen simulation window 71. To maximize screen area available for the simulation and provide a more immersive environment, simulation window 71 can be displayed full screen. The navigation controls allow the user to navigate forward using forward button 65 and backward using back button 64 through one or more simulation or CBT tracks 12. During navigation, if CBT track 15 is displayed, a partial screen CBT window 60, as shown in FIG. 7, or a full screen CBT window 80, as shown in FIG. 9, will reappear.

FIG. 9 is a schematic diagram of an embodiment of the interface illustrating use of full screen CBT window 80. When background theories and concepts are introduced that do not directly reference the simulation or large diagrams are shown, the use of a full screen CBT window maximizes available multimedia display area. CBT tracks 15 can be made up of one or more pages 18a-18n. When CBT tracks 15 are made up of a plurality of pages 18a-18n, forward button 65 and back button 64 allow the user to move through the pages. When the end or beginning of CBT track 15 is reached, the next or previous CBT or simulation track can be displayed.

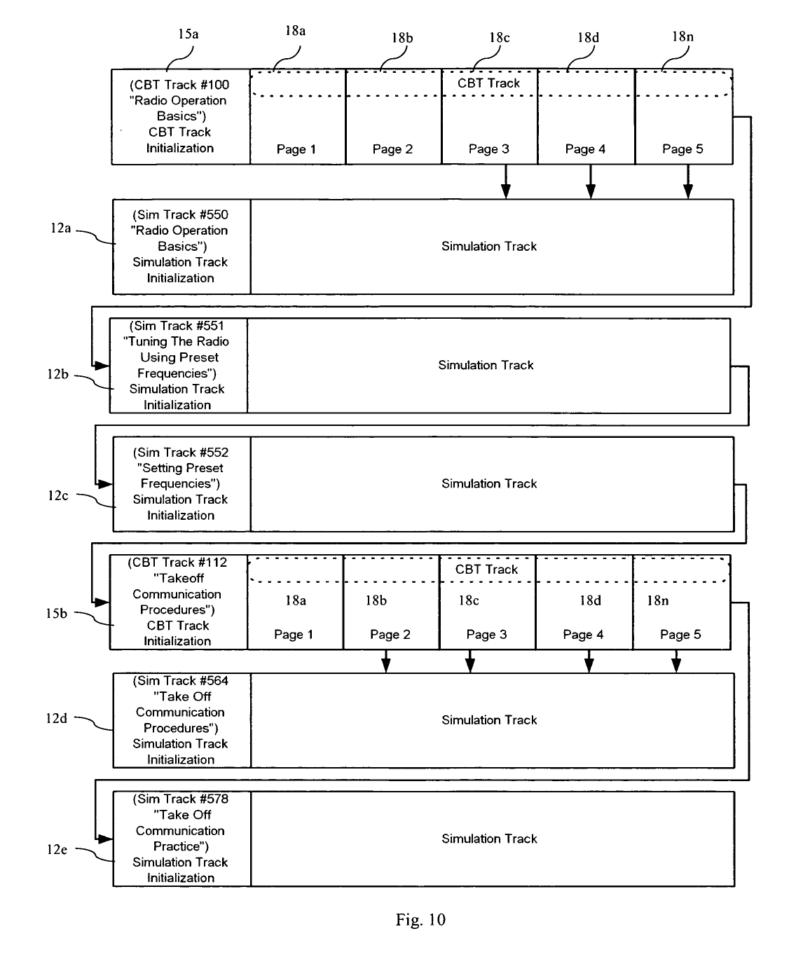

FIG. 10 depicts a preferred embodiment of CBT tracks 15 and simulation tracks 12 used in an example training lesson. CBT track 15a, referred to as #100 comprises a plurality of CBT pages 18a-18n that refer to highlighted radio controls present in simulation track 12a, referred to as Simulation Track #550. At the start of the lesson, two introductory CBT pages 18a and 18b are displayed full screen. CBT pages 18c-18n, pages 3 through 5, are displayed in a partial screen CBT window. The CBT can discuss specific radio controls while each control is highlighted in the simulation window displayed adjacent to CBT pages 18c-18n. The user advances through pages 18a-18n by activating forward button 65 and can review information on the previous page by activating back button 64. Display of part and full screen CBT windows as appropriate for each page or track, and synchronization between the CBT and simulation windows is automatically maintained by the interface.

After reviewing page 18n, activating forward button 65 displays simulation track 12b, referred to as Simulation Track #551 in a full screen simulation window. For example, simulation track 12b can be an exercise for a user tuning the radio using preset frequency controls. Forward button 65 on the interface is not active until simulation track 12b is completed by the user in order to ensure that the user has completed the exercise successfully.

Simulation track 12c, referred to as Simulation Track #552, is a more advanced exercise. For example, simulation track 12c shows a user how to set a preset frequency. During simulation track 12c, if a user desired to review information from page 4 of CBT track #100, the user could activate back button 64 three times. The first activation of back button 64 returns the user to simulation track 12b, referred to Simulation Track #551. The second activation of back button 64 returns the user to CBT track 15a, CBT track #100 and page 18n, page 5. The third activation of back button 64 returns the user to page 4. To return to simulation track 12c, Simulation Track #552, the user can activate forward button 65 three times. Since the exercise in simulation track 12b, Simulation Track #551, had previously been completed by the user, forward button 65 is enabled at the start of simulation track 12b allowing the user to proceed immediately to simulation track 12c, Simulation Track #552. Menu button 68 also allows users to navigate between simulation tracks 12 and CBT tracks 15. In one embodiment, a required sequence can be enforced by only allowing random access using menu button 68 to simulation tracks 12 and CBT tracks 15 that the user has already completed.

After simulation track 12c, Simulation Track #552, has been completed, forward button 65 becomes active and the user can activate forward button 65 to advance to the next section of the lesson which starts with CBT track 15b, referred to as #112, “Takeoff Communication Procedures”. After full screen CBT page 18a of background information, the user is instructed on the procedure using a combination of partial screen CBT and simulation track 12d, Simulation Track #564. From pages 18b-18n, page 2 to 5, the user is asked to perform steps of the simulated procedure. During user interactions, CBT pages 18b-18n can coach and provide feedback. On each page 18b-18n, once the user has completed the interaction successfully, the lesson creator has set up the track to automatically advance the user to the next page. After page 18n, page 5, has been completed, the user is advanced to simulation track 12e, Simulation Track #578, “Takeoff Communication Practice”. In simulation track 12e, using full screen simulation, the user can practice the communication procedure. During full screen simulation, feedback and guidance can be provided with a text to speech engine or with text overlaying the simulation.

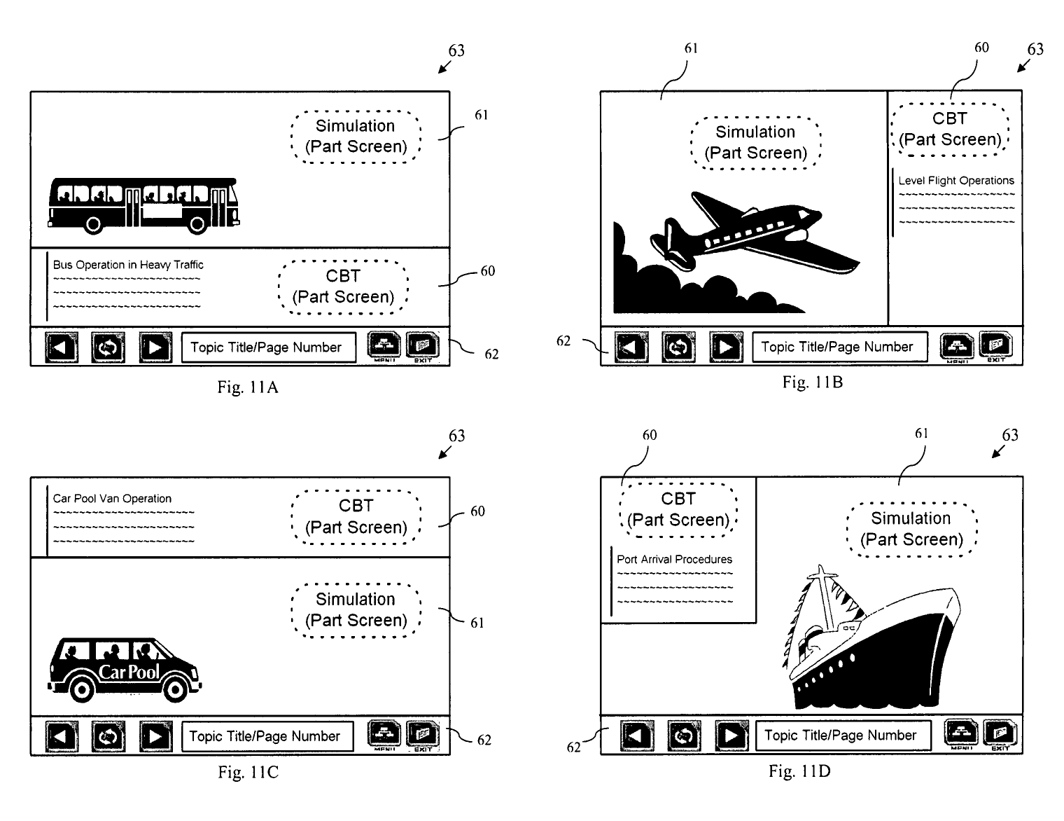

Fig. 11A-11D are schematic diagrams of an embodiment of the interface illustrating a range of standardized sizes and locations for partial screen CBT window 60. The range of sizes and location of the partial screen CBT window provide flexibility for the simulation environment being displayed. For example, training scenarios that deal with the railroad industry could benefit from having the partial screen CBT window 60 on top of screen 63 to provide a longer aspect ratio simulation window as shown in

FIG. 11C. Navigation bar 62 can also be located along the top or side of screen 63 based on user requirements.

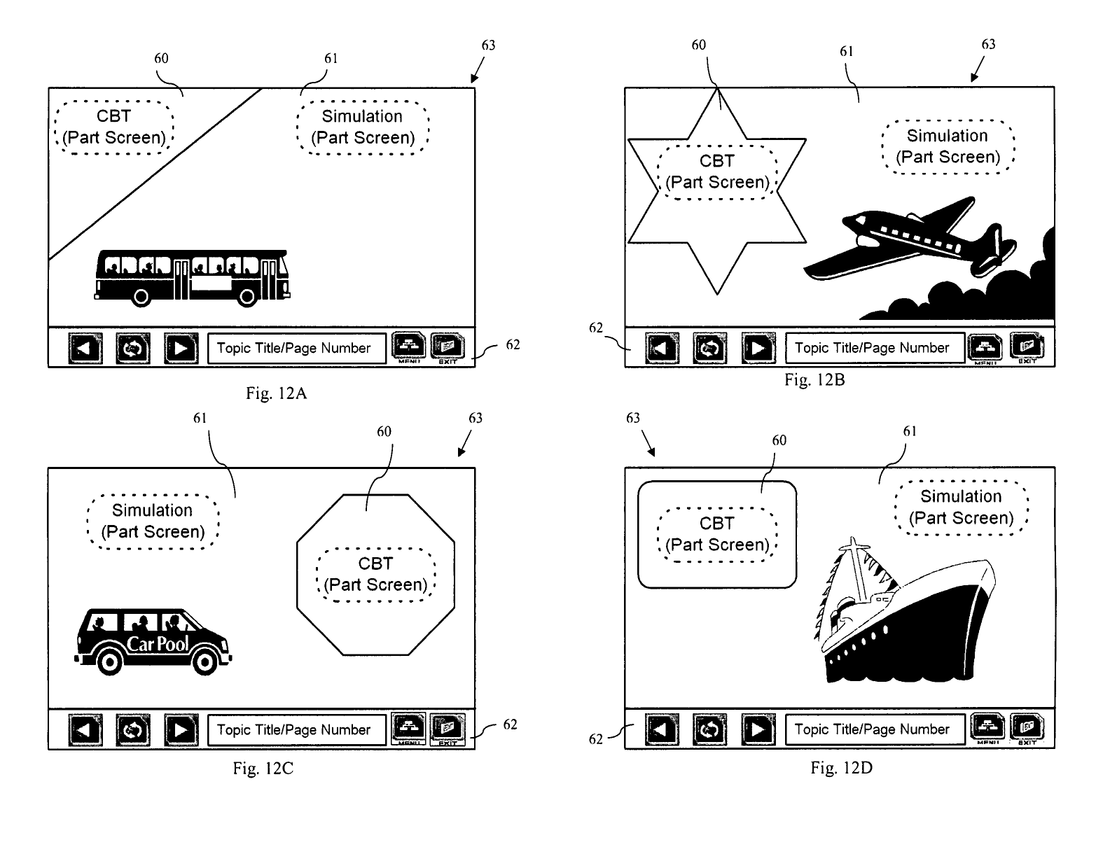

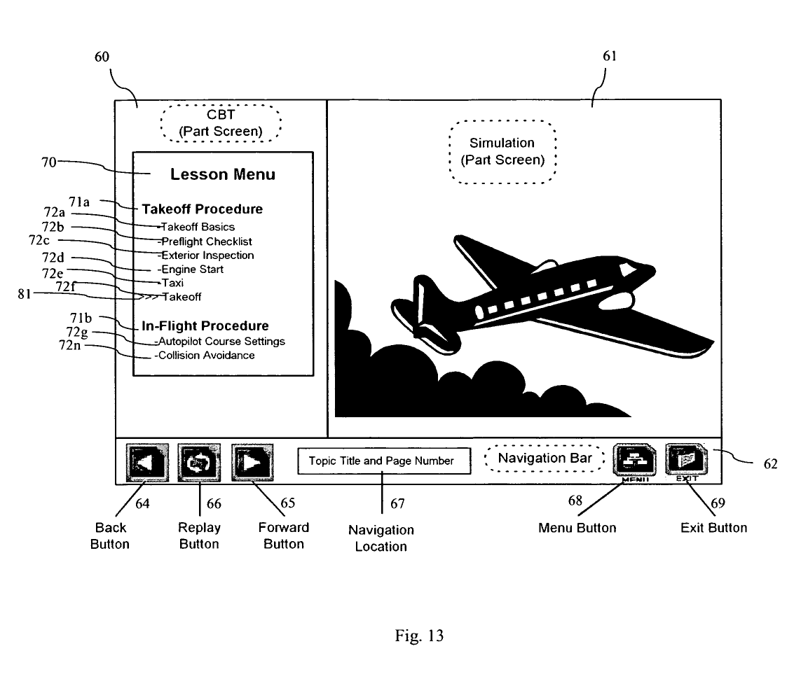

FIG. 12A-12D are schematic diagrams of alternate embodiments of the interface illustrating user customizable size, shapes and location for partial screen CBT window 60.

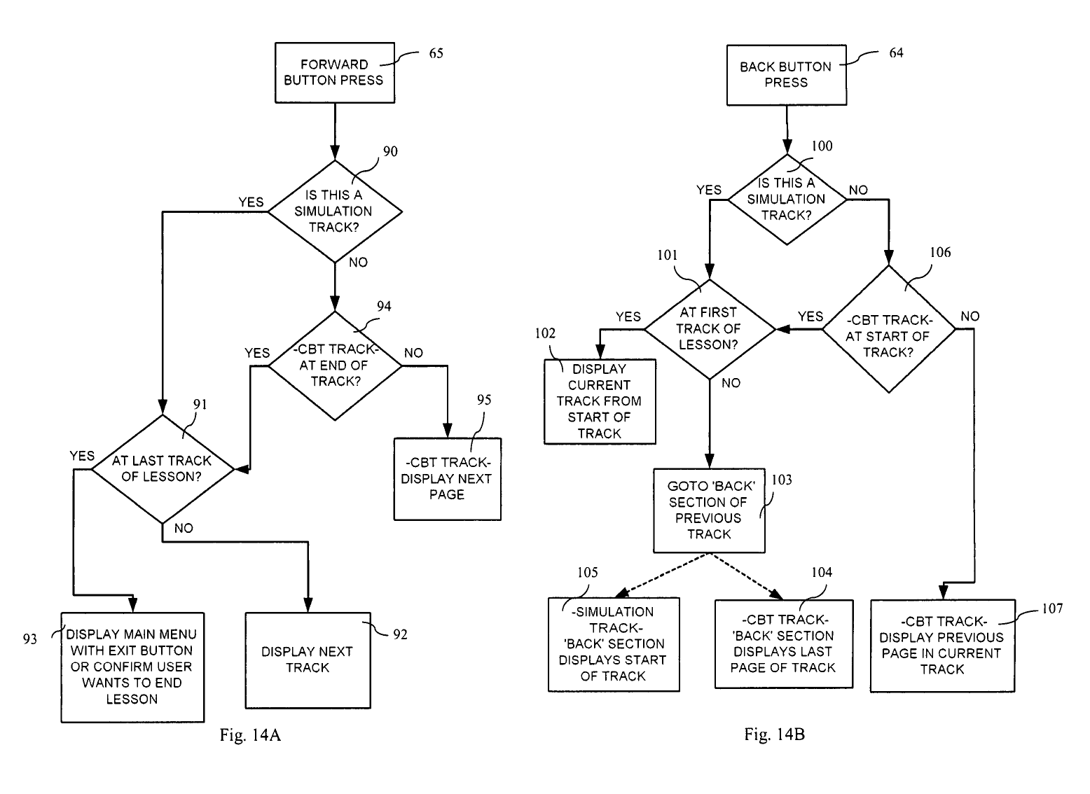

FIG. 13 is a schematic diagram of a preferred embodiment of the interface displaying a navigation menu. Shown in FIG. 13, the grouping of tracks within a hierarchy allows the menu to display an expandable node tree structure containing segments and topics which simplifies navigation for the user. When the user activates menu button 68, lesson menu 70 appears. Lesson menu 70 can list segments 71a-b and topics 72a-n which are comprised of one or more simulation tracks 12 or CBT tracks 15. If a required sequence for a lesson is being enforced, then tracks or topics which have not yet been started can be shown as not currently available for selection, for example, as grayed out. Indicator 81, such as a caret alongside the presently displayed topic, indicates the user's current position in the lesson. In one embodiment of the invention, lesson menu 70 displays an OK and CANCEL button (not shown); to navigate to a topic a user would highlight a topic by single clicking on it, and then click OK; the CANCEL button would close the menu. Alternatively, a user can navigate to an item by double clicking on it, with lesson menu 70 being closed by a second click on menu button 68 if the user does not make a selection.

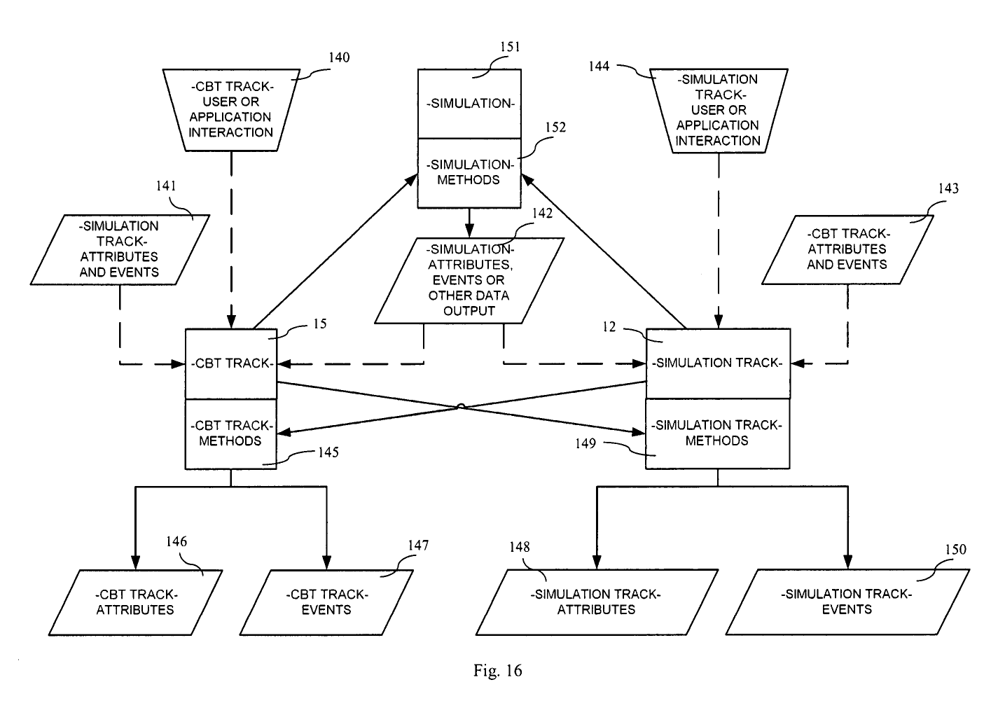

FIGS. 15A-15C are flow charts depicting the logic for the respective replay, menu and exit buttons. It will be appreciated that other navigation controls can be used with the teachings of the present invention.

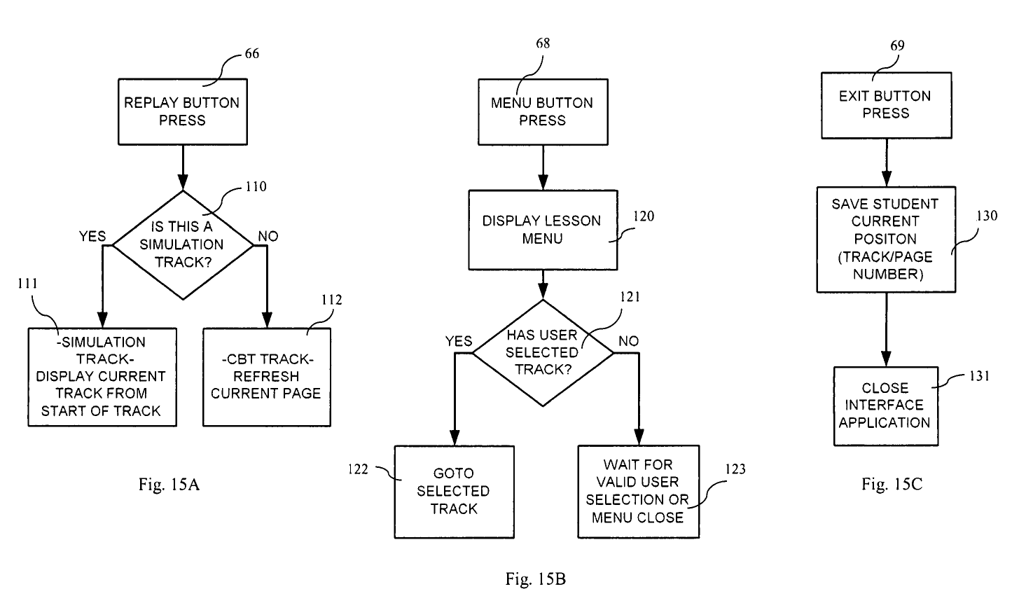

FIGS. 14A-14B are flow charts showing respective forward and back navigation. A preferred embodiment of the invention permits the user to navigate seamlessly through both CBT tracks 15 and CBT pages 18a-18n and simulation tracks 12. To accomplish this, the behavior of the forward button is determined from whether the interface is currently showing: A) a CBT track (for purpose of navigation this includes CBT track and simulation track) or B) a simulation track.

In FIG. 14A, upon pressing forward button 65, a decision is made in block 90 if the currently displayed track is a simulation track 12. If a simulation track is being displayed, a determination is made in block 91 if it is the last track of the lesson. If the current track is not the last track of the lesson, the next track 12 will be displayed in block 92. If the current track is the last track of a lesson, the user can be prompted to confirm exit of the lesson or be shown a main menu with an exit button, in block 93.

If a CBT track is being displayed and the forward button 65 is pressed, a determination is made in block 94 if the current track is at the end of the track. If the current CBT track is not on the last page of the track, in block 95, the interface advances to the next CBT page. If the last page of the CBT track is being displayed and the current track is not the last track in a lesson, the display will advance to the next track, in block 92. If the last CBT page of the final track in a lesson is currently being displayed, the user will be prompted to confirm exit of the lesson with an exit button or be shown to a main menu, in block 93.

In FIG. 14B, upon activating back button 64, a determination is made in block 100 whether the currently displayed track is a simulation track. If the currently displayed track is a simulation track, a determination is made, in block 101, if the current display track is the first track of the lesson. If the current simulation track is the first track of the lesson, the current simulation track is displayed from the start of the track, in block 102. If the current simulation track is not the first track of the lesson, the display navigates to the “back” section of the previous track, in block 103, and displays the start of the previous simulation track, in block 105, or displays the last page of a CBT track, in block 104.

When the back button is clicked with a CBT track displayed, if the current track is not the first page of a CBT track, in block 106, the previous page in the current CBT track is displayed, in block 107. If this is a CBT track on the first page of the track, in block 106, and the current track is the first track of the lesson, in block 101, the current track is restarted, in block 102. If this is not the first track of the lesson, in block 101, then the display navigates to the “back” section of the previous track, in block 103. The “back” section of a CBT track, in block 104, displays a CBT track's last page, or the start of the previous simulation track, in block 105. Thus the flow from the current track to the last page of a previous CBT track provides a consistent back and forward navigation through CBT tracks and simulation tracks.

In FIG. 15A, if replay button 66 is activated, a determination is made in block 110 if the current track is a simulation track. If the current track is a simulation track, the current simulation track is displayed from the start of the track, in block 111. If the current track is not a simulation track, the CBT track is refreshed and displayed from the start of the current page, in block 112.

In FIG. 15B, if menu button 68 is activated, the lesson menu is displayed in block 120. In block 121, a determination is made if the user has selected a track. If the user has selected a track, the interface goes to the selected track, in block 122. If the user has not selected a track, the interface waits for a valid user selection, or for the user to close the menu, in block 123. A timer can be used in block 123 to close the menu if the user has not made a selection before a predetermined period of time.

In FIG. 15C, if exit button 69 is activated, the current navigation location for the lesson, for example, a track or page number, is saved in block 130. In block 131, the interface application is closed.

FIG. 16 depicts communication between CBT track 15, simulation 151, and simulation track 12. When a training lesson is launched, or the user navigates to a new track or CBT page, simulation track 12 calls simulation method 152 and provides data from the simulation track initialization information 14 from the simulation track file to set simulation 151 to a known simulation start point. This capability of simulation track 12 to initialize simulation 151 to a known start point allows the lesson creator to display specific CBT content alongside a specific simulation demonstration or exercise. Following initialization of simulation 151 to a known point, simulation track 12 continues to monitor and control simulation 151, while communication between simulation track 12 and CBT track 15 maintains synchronization of the joint simulation and CBT display.

In the preferred embodiment of the invention, CBT track 15 displays multimedia training content, responds to CBT user and application interactions 140, and monitors relevant simulation track attributes and programmatic events 141. Attribute changes and programmatic events generated by simulation track 12 and simulation 151 can thereby cause a CBT track program response (including changes in the multimedia content display), create a change in CBT track attributes 146, or cause a CBT track programmatic event 147 to be raised. While both simulation track 12 and CBT track 15 can directly monitor simulation attributes, programmatic events, and other output data generated by simulation 142, and call simulation methods, in the preferred embodiment of the invention, simulation track 12 will be responsible for the control of, and communication with simulation 151.

CBT track 15 and simulation track 12 can raise programmatic events. Simulation track 12 can monitor and respond to programmatic events 147 raised by CBT track 15; which programmatic events to monitor can be specified during the creation of simulation track 12. Likewise, CBT track 15 can monitor and respond to programmatic events 150 that are raised by simulation track 12.

Examples of simulation track attributes 148 can be the number of times a user has practiced a procedure, and how many practice attempts were required before the procedure was performed successfully. When a simulation procedure is performed successfully, simulation track programmatic event 150 can be raised, which signals CBT track programmatic method 145 to advance the CBT track 15 to the next page of instruction. When CBT track 15 moves to a new page, this will typically raise CBT track programmatic event 147 which notifies simulation track programmatic method 149 to present a simulation display appropriate for the start of the new CBT page.

Similarly, simulation track 12 monitors relevant CBT track attributes and programmatic events 143 and simulation attributes and events 142. An example of communication between the CBT track 15, simulation track 12 and simulation 151 is an animated Flash diagram displayed by CBT track 15. If a user closes a hydraulic valve depicted by an animated CBT diagram, this CBT track user interaction 140, will cause the activation of the appropriate CBT track programmatic method 145, which will set CBT track attribute 146 representing the valve to a closed state. Since this CBT track attribute has been flagged as relevant to simulation track 12, simulation track programmatic method 149 will execute when the CBT attribute changes. Therefore, simulation track 12 will react to the CBT track valve closure by calling simulation programmatic method 152 in simulation 151 to close the corresponding valve. An example of a CBT track application interaction 140 would be a timer within the Flash content that causes the animated hydraulic valve to close after a specific period of time has elapsed.

If the user flips a switch in simulation 151 to reopen the valve in the simulation, the valve's simulation attribute change 142 will be detected by simulation track 12; in response, simulation track programmatic method 149 calls CBT track programmatic method 145 to change CBT attribute 146 representing the valve state back to open, thus causing the on-screen CBT display to reopen the display valve and allow resumption of animated hydraulic flow. However, simulation changes to switches that affect only aircraft navigation lighting will not be communicated to CBT track 15 because those simulation attributes have not been flagged in the simulation track by the lesson creator as relevant to the CBT display.

CBT track 15 can also monitor simulation attributes and events 142, along with calling simulation programmatic methods 152 and setting simulation attributes; whether communication from CBT track 15 to simulation 151 is routed through simulation track 12 or whether CBT track 15 communicates directly with simulation 151 is a communication decision left to the discretion of the lesson creator utilizing a graphical authoring tool to create CBT and simulation tracks, or the programmer manually coding tracks; the multiple channels of communications maximize the flexibility and capabilities of the invention.

CBT track 15 can call simulation track programmatic methods 149 to trigger actions such as the display of a highlight over a simulated instrument panel button while CBT instructional text bullets are simultaneously instructing the user on how to operate the simulated instrument panel. Simulation track 12 can also call CBT track programmatic methods 145 to trigger actions in CBT track 15 such as advancing to the next page after a user has performed a successful aircraft take off.

Another example of communication using programmatic method calls between tracks is the display of a help screen in the CBT window when a user right clicks on an instrument panel button in the simulation window. In a case where simulation 151 has not been programmed to respond to a right mouse click, simulation track 12 can monitor and respond to user interaction 144. Hence, a right mouse click will cause simulation track programmatic method 149 to call CBT track programmatic method 145 with the name of the button to display a help screen for. Thus, when an instrument panel button is right clicked in the simulation window, the CBT window is able to display a help screen for the selected button. Alternatively, simulation track 12 can overlay a text tool tip over the simulation display, beside the simulation button that was clicked; the tool tip could contain the button name and/or brief description of the button's function.

The ability of the simulation track to set the simulation to a known simulation starting point, and the attributes, programmatic methods and programmatic events of the CBT and simulation tracks provides communication that maintains synchronization between the CBT track, simulation track and the simulation. Hence, the display output of the present invention is a fully interactive, navigable, and synchronized multimedia and simulation display.

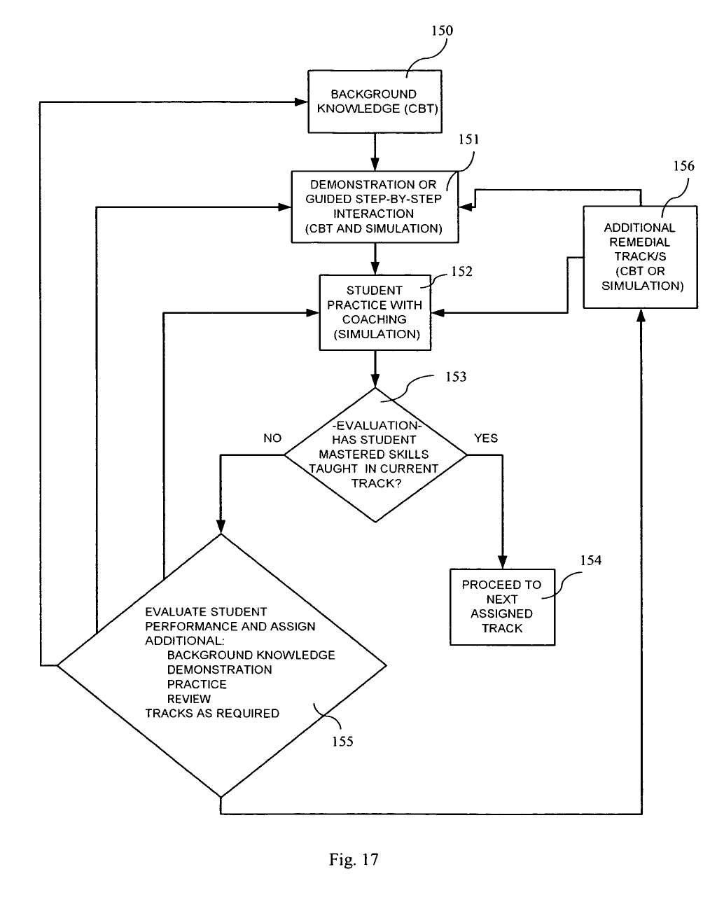

FIG. 17 is a high level flow chart depicting use of the invention to implement a dynamic syllabus and Adaptive Simulation Training model. In block 150, a full screen CBT window, or a combination of full screen and partial screen CBT can be used to provide background knowledge regarding a procedure or technical operation. In block 151, the interface provides a simulated demonstration of the procedure or guides the user through a step-by-step operation of the equipment. In block 152, a user can practice and be coached on the operational procedure. After the user has practiced the procedure, an evaluation of the user's skills can occur, in block 153.

In block 153, a determination is made if the user has mastered the skill taught in the current track. If the user has mastered the operation, the next track is displayed, in block 154. If the user is not performing to a satisfactory standard during the practice or at the end of the evaluation, then an automated analysis of user's skill gaps is performed, in block 155. To fill user skill gaps, block 155 can assign previously viewed tracks or additional remedial CBT or simulation tracks 156. The remedial tracks 156 can include additional background knowledge, demonstration, and practice tracks. For instance, if a user was not keeping aircraft wings level during a loop, a demonstration track which illustrates looking left/right to verify wing alignment against the horizon can be assigned. After additional practice 152, the user can be evaluated 153 and if their performance meets defined standards, the display will advance to a next track or topic of the assigned syllabus 154.

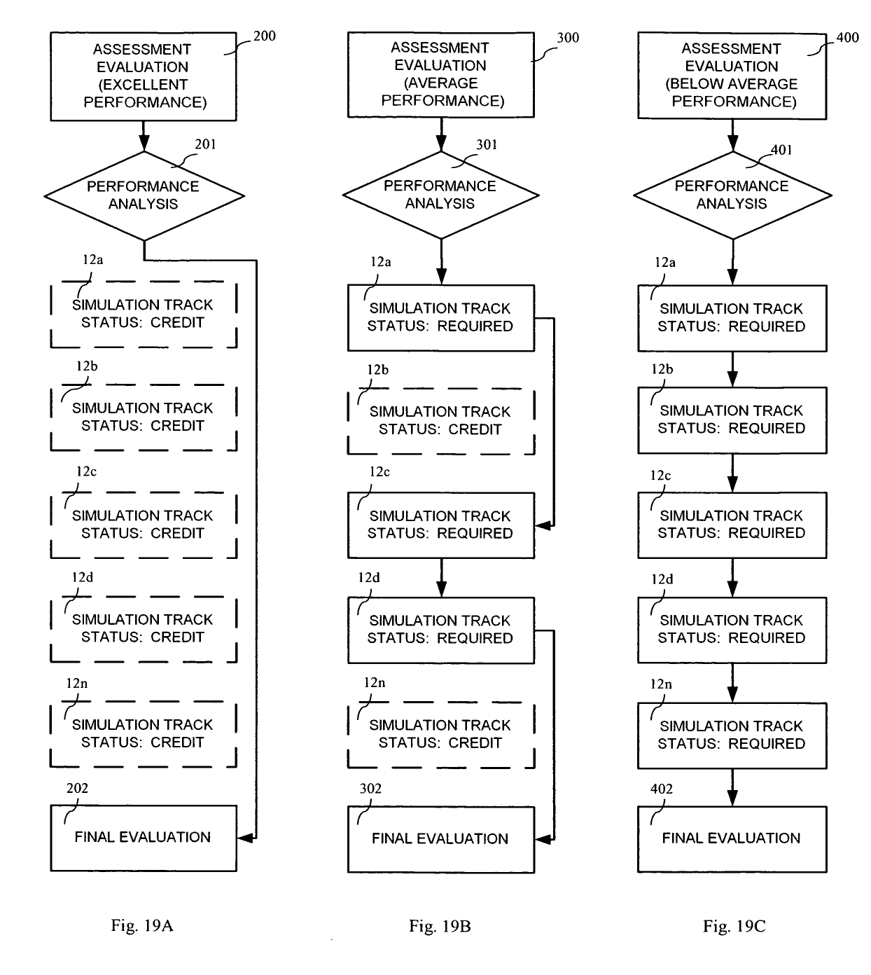

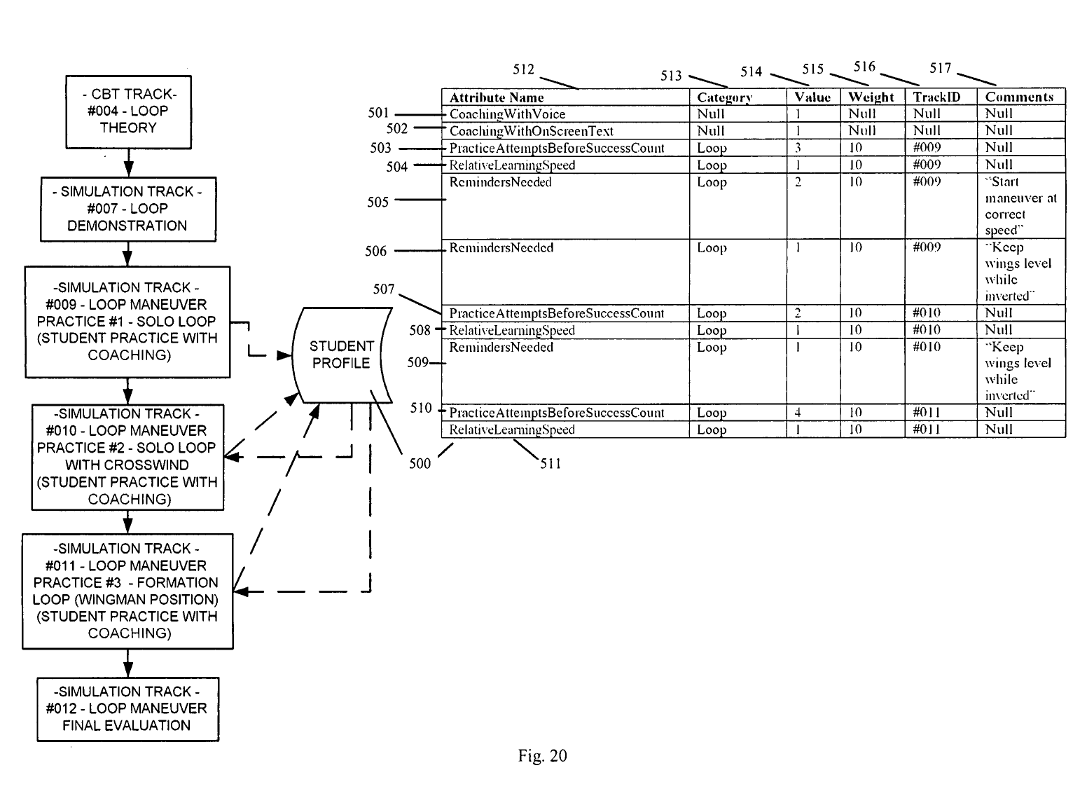

FIG. 18, 19 and 20 are flow charts showing three types of Adaptive Simulation Training using the interface of the present invention. FIG. 18 details a remedial Adaptive Simulation Training process. FIG. 19 shows a predictive Adaptive Simulation Training process. FIG. 20 shows a continual evaluation Adaptive Simulation Training process utilizing a student profile. Remedial, predictive and continual evaluation Adaptive Simulation Training can be used alone or in combination with each other, or with other types of Adaptive Simulation Training not shown in these figures. The illustrated processes can be applied to tracks or groupings of tracks previously referred to as lesson topics.

FIG. 18 is a flow chart showing functionality of a dynamic syllabus used to provide Adaptive Simulation Training. FIG. 18 illustrates operational details for the high level overview illustrated in FIG. 17. In the preferred embodiment of the invention, a database, not shown in FIG. 18, stores the syllabus for a user course, along with tracks to be used in each lesson. The dynamic syllabus buffer 160, stores current display track register 161 and remediation track queue 162. While displaying syllabus assigned tracks, current display track register 161 is populated with the assigned track that is presently being displayed to the user. When the track completes, completion data for the track is stored for this user in a database. The interface will load the next required syllabus track into the current display track register which will cause this new current display track to be displayed to the user. While the user is performing tasks to the expected standards, remediation track queue 162 remains empty.

Following a user evaluation, the interface executes a performance analysis 153 to determine whether the user has mastered the assigned tasks; if the user has mastered the assigned tasks, the user will proceed to the next track, in block 154.

However, if the performance analysis 153, determines a user did not master the assigned tasks, then remedial tracks will be assigned to improve user performance. An example dynamic syllabus buffer 163 illustrates a single remedial track having been assigned to the user. During the analysis of user performance 153, the system determined that the user exhibited a single problem of not keeping the aircraft wings level during the loop maneuver. The dynamic syllabus functions as follows: in block 155, the user is notified that task performance did not meet required standards in a specific area; next in block 156, remedial Track #022 Wing Level Practice is placed in the current display track register 164 and Track #009 Loop Maneuver is placed in the remediation track queue 165. Following completion of the remedial track #022, track #009 moves from the remediation track queue 165 to the current display register 164 thereby requiring the user to repeat Track #009 Loop Maneuver. The assignment of additional remedial and evaluation tracks ensures that the user has mastered the skills required to perform the maneuver; if second and subsequent evaluation attempts are not completed to a high standard, additional remedial tracks will be assigned as required.

Example dynamic syllabus buffer 166 illustrates an analysis of user performance where the user performed poorly in multiple evaluation areas. In this case, the dynamic syllabus functions to notify the user of performance problems, in block 155, and block 156 places remedial track #022 Wing Level Practice in the current display track register 167. The following tracks are placed in the remediation track queue 168: Track #014 Inverted Flying; Track #012 Basic Aerobatics; Track #022 Try Loop Again Intro; Track #007 Loop Demonstration; and Track #009 Loop Maneuver. Again to ensure skill mastery, following completion of the multiple remedial tracks, the user is required to repeat Track #009 Loop Maneuver which includes a skills evaluation at that will again trigger remediation track assignment if not performed satisfactorily. When appropriate, alternative practice and evaluation tracks can be developed and used in place of the original practice/evaluation track. Completion and scoring data is kept on all remedial tracks assigned to the user along with each attempt at the originally assigned dynamic syllabus track. This permits summative evaluation and instructor analysis of user performance. In an alternative embodiment of the invention, remedial tracks could be added to a user's permanent syllabus rather than a remediation track queue.

FIGS. 19A-19C are flow charts showing predictive Adaptive Simulation Training process. The random access navigation capabilities of the interface permit a dynamic assignment of content based on an assessment evaluation used to determine user skills and needs. Assessment evaluations 200, 300 and 400 provide respective examples of excellent, average and below average performance evaluation. Below each assessment evaluation, simulation tracks 12a-12n, comprise a section of a user's training syllabus. When first assigned to a user, the initial status of these tracks is required. Accordingly, the tracks are a mandatory part of the user's assigned training content. At the start of the illustrated curriculum section, an assessment evaluation 200, 300, and 400 is performed to gauge the users academic and/or performance skills. The evaluation can be any combination of CBT or simulation. Based on high performance in specific areas, performance analysis blocks 201, 301 and 401 will change the status of appropriate subsequent tracks from required to credit; tracks that are given credit do not have to be completed because the user has already demonstrated an understanding of the content presented by those tracks. Data can be stored in the user's completion record for each track indicating whether the user “tested out” or completed the track.

Assessment evaluation 200 of excellent performance provides a status of credit in each of the simulation tracks 12a-12n subsequent to the evaluation. This user can either review any of these credited tracks or proceed immediately to the final evaluation in block 202 for the section. Assessment evaluation 300 of an average user performance generates a mix of credit and required status in the simulation tracks following this evaluation. Review of the tracks with a credit status is optional, while the required tracks must be completed before access to a final evaluation in block 302 is granted. A poorly performed assessment evaluation 400, requires the user to complete all subsequent tracks 12a-12n prior to taking the final evaluation in block 402.

FIG. 20 is a flow chart showing a continual evaluation Adaptive Simulation Training process. In this process, individual tracks vary presentation of simulation, or integrated simulation and multimedia content, based on user skills, needs and preferences.

While each track is being completed, user attribute records are stored regarding user performance, needs and preferences in student profile datatable 500. Records 501 and 502 are preference attributes indicating that this user has either selected, or has been evaluated as performing better with automated coaching that uses both voice instruction and text on screen. During initialization, each track reads preference records, then delivers content based on those preferences.

Data that records user performance characteristics is also stored in student profile datatable 500. Records 503, 507 and 510 indicate how many times a user needs to practice a maneuver prior to successful completion. Records 504, 508, and 511 refer to a record of “Relative Learning Rate” indicating a weighted value for an identified track ID. Based on student profile past performance information stored in datatable 500, simulation tracks present content specific to the learning needs of the current user.

An example of student profile information being used to vary the presentation of simulation track content is that a user who has been evaluated as having an accelerated learning rate can be shown a single reasonably fast paced demonstration for procedures being taught. In contrast, users with normal or remedial learning rates may receive two or three demonstrations covering the same procedure. Demonstrations for normal or remedial learning rates may also be broken down into smaller steps and contain more background information to meet the learning needs of users assessed as having a slower learning rate. These more detailed demonstrations are available on an optional basis for an accelerated learning rate user who desires additional instruction. Users with a slower learning rate may also be assisted with additional practice sessions within a simulation track.

Any information suitable for tailoring the presentation of simulation content to meet a user's skills, needs and preferences can be stored in student profile datatable 500. For example, key coaching tips that a user needs during procedure performance are recorded as “RemindersNeeded” in records 505, 506 and 509. Prior to performing similar procedures in the same or subsequent tracks, users are provided with a reminder on key performance areas of which problems occurred with in the past. An example is the automated coaching reminder, “Remember: Start maneuver at correct speed” of record 505.

In addition to adapting the presentation of tracks to individual user needs, not shown in FIG. 20, is the use of information in the student profile datatable 500 to assign appropriate tracks or topics to the current user. This process would be similar to that described in FIGS. 19A-19C, with student profile datatable 500 information being used in combination with, or instead of assessment evaluation data.

User track completion data, including scores and performance in specific areas, can also be used in lieu of, or in combination with information stored in student profile datatable 500 to vary the presentation of simulation track contents, or to assign appropriate tracks to a user.

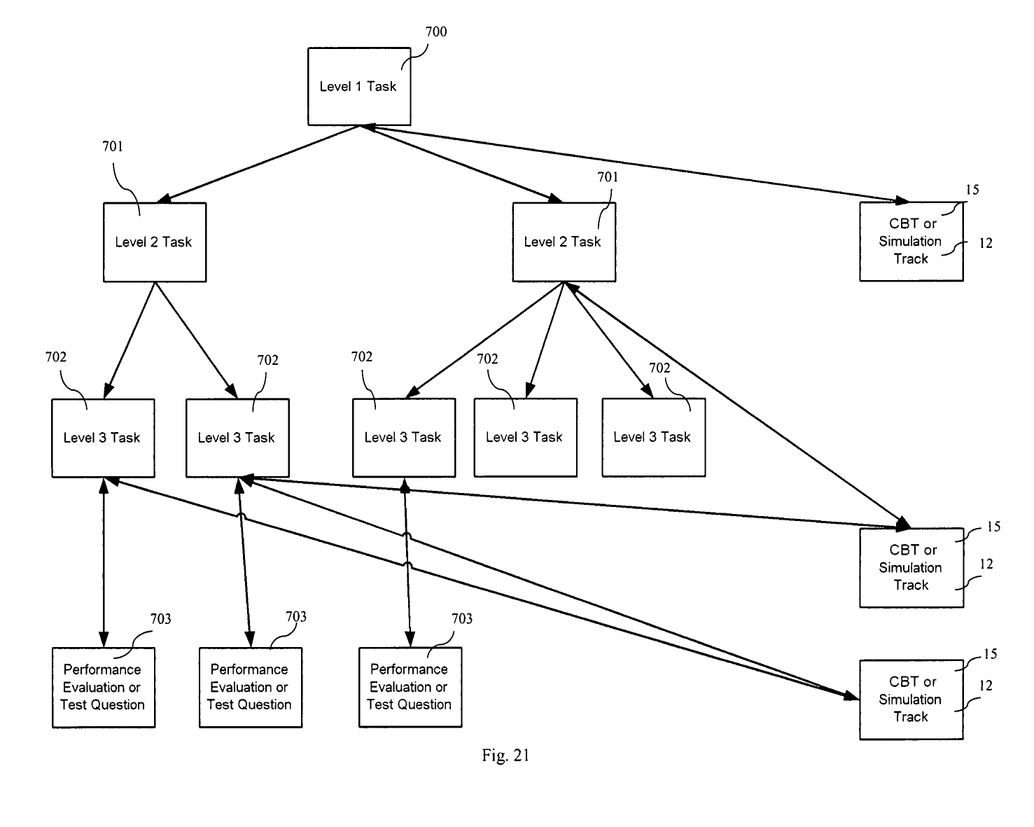

FIG. 21 depicts mapping of simulation 12 and CBT 15 tracks to a hierarchal task or learning objective structure. Level 1 task 700 can be mapped to CBT track 15 or simulation track 12. For instance, Level 1 task 700 can also be mapped to one or more level 2 tasks 701. Level 2 task 701 can be mapped to CBT track 15 or simulation track 12. Level 2 task 701 can also be mapped to one or more level 3 tasks 702. Each of level 3 tasks 702 can be evaluated or tested in block 703. Tracks can also be mapped to any user defined training statements or custom learning structures. In a preferred embodiment of the invention, this allows user scoring and evaluation to be cross-referenced against tasks or objectives for summative evaluation analysis or item analysis and enables navigation by task/objective or for other user defined purposes. Associative mapping of tracks can also be used to ensure training and/or evaluation is provided for each task, objective or other user defined category. In addition, associative mapping permits scores to be generated for tasks and objective performance. For instance, if a series of level 3 tasks 702 were to fly a Loop, Split-S and Aileron Roll, the scores for tracks mapped to those tasks could be use to calculate aggregate or individual scores for the associated level 3 tasks 702.

Tracks can be mapped to different levels of a task or objective hierarchy as one track can incorporate all of the tasks that fall beneath a high or top level task or objective.

Alternatively, a task may cover only a single level 3 task 702. In an alternative embodiment of the invention, navigation to training tracks can occur directly from a task hierarchy where selection of a task can display a list of all tracks mapped to that task, with the ability to launch the displayed tracks.

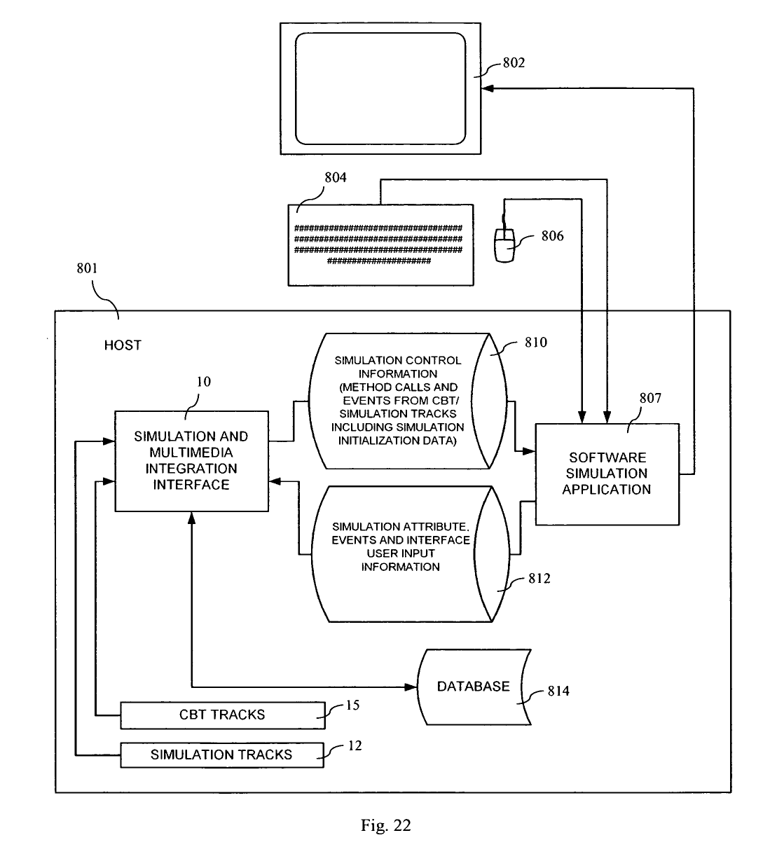

FIG. 22 is schematic diagram illustrating interface invention and host hardware system 801. Hardware system includes output display 802, keyboard 804 and mouse 806.

Simulation tracks 12, CBT tracks 15, simulation 807 and simulation and multimedia interface 10 are stored and execute on host system 801. Program code and data can reside on hard drive, in memory, on optical media, other digital storage or be delivered to host via the internet or other transmission medium. Simulation control information 810, including simulation initialization data, programmatic method calls and programmatic events from the CBT/simulation tracks, is communicated from the interface 10 to the software simulation 807. Simulation attribute and event data, along with interface user input information 812 is communicated from the simulation 807 to the interface 10. Database 814 stores information generated by the interface 10, including student assessment and performance data.

In alternative embodiments of the invention, the output display 802 can be any form of display device including multiple monitors, plasma or LCD television screens, or projected images. Any type of input device can be utilized including joystick/throttle/steering wheel/pedal controls, or use of a partial or full hardware representation of the simulated device. In other embodiments of the invention, the host hardware system 801 need not be a traditional personal computer system. Any processing system capable of executing a software simulation can be used to host the invention, including hardware devices like digital processors within an armored fighting vehicle, a full size aircraft simulator, game console, laptop or tablet computer, web-enabled television, or any electronic device or digital processor, in general. Use of the interface within a functional vehicle, aircraft, or other complex equipment as an embedded training tool or as a real-time “help” provider are practical alternative embodiments of the invention.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method of integrating simulation and multimedia information comprising the steps of:
determining at least one simulation track, said simulation track comprising simulation track initialization information comprising a series of predefined initialization points to delineate a reference to said simulation;
determining at least one computer based training (CBT) track, said CBT track comprising CBT track initialization information comprising a series of predefined attributes to delineate a reference to said multimedia information;
navigating and accessing said simulation using said simulation track; and
navigating and accessing said multimedia information using said CBT track.

2. The method of claim 1 further comprising the steps of:
initializing said simulation to a known simulation start point using said simulation track initialization information to provide navigation and access of said simulation using said simulation track; and
initializing CBT display window to a known start point using said CBT track initialization information to provide navigation and access of said multimedia information.

3. The method of claim 2 wherein said simulation track initialization information comprises one or more of the following parameters selected from the group consisting of type, location and heading of one or more controlled entities, entity status information, global environment information and type, location, heading and status information for all other entities present in the simulation.

4. The method of claim 1 wherein said simulation track further comprises a simulation track body comprising attributes, programmatic methods and the ability to raise programmatic events and said CBT track further comprises a CBT track body comprising attributes, programmatic methods, and the ability to raise programmatic events and further comprising the step of:
communicating at least one said attribute of said simulation track and/or at least one said attribute of said CBT track between said simulation track and said CBT track, along with use of said track programmatic methods and raising of said track programmatic events thereby providing synchronization and integrated display of said simulation and said multimedia information.

5. The method of claim 1 wherein said simulation track body comprises attributes, programmatic methods and programmatic events that generate functionality for one or more tasks selected from the group consisting of: monitoring and responding to simulation programmatic events, attributes and other data output; monitoring and responding to said CBT track programmatic events and attributes; monitoring and responding to said simulation track programmatic events and attributes; responding to user interactions; displaying text; activating text to speech engine; engaging camera moves; highlighting control panels or buttons; changing values of simulation attributes; changing values of said simulation track attributes; changing values of said CBT track attributes; specifying enabled or disabled state of navigation controls; looping, branching or jumping to different program flows within a current said simulation track or another said CBT track or said simulation track; providing demonstrations of and coaching on, instrument operation, procedures, and maneuvers; evaluating user instrument operation, performance of procedures or maneuvers; storing data on user performance, skills, needs and preferences; exposing simulation track programmatic methods that can be called by said external at least one CBT track or at least one simulation track or the simulation to trigger execution of program code within said at least one simulation track; raising simulation track programmatic events to which other of said at least one CBT track or at least one simulation track or the simulation can respond; calling simulation programmatic methods to generate simulated malfunctions, warnings or other simulation actions.

6. The method of claim 1 wherein said CBT track initialization information comprises one or more of the following parameters: a unique track identifier; initialization data for CBT track attributes which include a total number of pages in the track, and initialization data for each page including: filename/s or database location of static or interactive content to be displayed; content formatting instructions specifying details of one or more of size and/or location of content on page, ID of associated simulation track; size of CBT window, type of CBT window, and location of CBT window; attributes to specify an initial enabled or disabled state of navigation controls; and CBT track initialization data which include the start state of any attributes of said CBT track that have been added to said CBT track by a lesson creator.

7. The method of claim 1 wherein a CBT track body of said CBT track comprises attributes, programmatic methods and programmatic events that generate functionality for one or more tasks selected from the group consisting of: display of one or more pages of multimedia information; monitoring and responding to simulation programmatic events, attributes and other data output; monitoring and responding to said CBT track programmatic events and attributes; monitoring and responding to said simulation track programmatic events and attributes; responding to user interactions; displaying multimedia information based on user interactions; changing values of simulation attributes; changing values of said simulation track attributes; changing values of said CBT track attributes; specifying enabled or disabled state of navigation controls; looping, branching or jumping to different program flows within a current said CBT track or another said CBT track or simulation track; providing demonstrations of and coaching on, instrument operation, procedures, or maneuvers; evaluating user knowledge, skills and performance; storing data on user knowledge, performance, skills, needs and preferences; exposing CBT track programmatic methods that can be called by said at least one CBT track or at least one simulation track or the simulation to trigger execution of program code within said at least one CBT track; raising CBT track programmatic events to which other of said at least one CBT track or said at least one simulation track or the simulation can respond; calling simulation track programmatic methods to generate simulated malfunctions, warnings or other simulation actions.

8. The method of claim 1 wherein said simulation track further comprises simulation track metadata said simulation track metadata comprising one or more parameters selected from the group consisting of identification number of said simulation track; title of said simulation track, subject keywords, identification numbers of other said simulation tracks or said CBT tracks referenced by said simulation track, and identification number of training tasks or objectives that are taught by said simulation track.

9. The method of claim 1 wherein said CBT track further comprises CBT track metadata, said CBT track metadata comprising one or more parameters selected from the group consisting of identification number of said CBT track, title of said CBT track, subject keywords, identification numbers of other said simulation tracks or said CBT tracks referenced by said or CBT track and identification number of training tasks or objectives that are taught by said CBT track.

10. The method of claim 1 wherein said at least one CBT track and said at least one simulation track are generated with a graphical authoring tool.

11. The method of claim 10 wherein said graphical authoring tool is used to provide one or more of the following: assign track identification, title, keywords, and metadata attributes to the simulation track; select a simulation snapshot file to be converted into a simulation track initialization file; create a new or edit an existing simulation track initialization file; specify one or more simulation track attributes, and private/public programmatic methods and programmatic events that can be raised; specify which programmatic events, attributes and data output of simulation to monitor, and the response; specify which programmatic events and attributes of said simulation track to monitor, and the response; specify which programmatic events and attributes of said CBT track to monitor, and the response; specify actions to take or custom code to execute in response to user interaction; display text; activate text to speech engine; engage camera moves; highlight control panels or buttons; specify enabled or disabled state of navigation controls; specify decision and looping branching for determining program flow within said simulation track or other said CBT tracks or said simulation tracks through use of programmatic method calls; call simulation programmatic methods to generate simulated malfunctions, warnings or other simulation actions; output said simulation track as a software code file.

12. The method of claim 10 wherein said graphical authoring tool is used to provide one or more of the following: assign track identification, title, keywords, and metadata attributes to said CBT track; add blank pages to said CBT track; specify size, type, and location of a CBT window for each page of said CBT track; add and format said multimedia information and/or resources for each said CBT track or a CBT track page of said CBT track; specify navigation controls to be enabled or disabled at page start-up and in response to interactions; specify a simulation track identification reference for said CBT track pages of said CBT track that are paired with said at least one simulation track; specify one or more of said attributes of said CBT track, programmatic events that can be raised and private/public programmatic methods; specify which programmatic events and attributes of simulation to monitor, and the response; specify which programmatic events and attributes of said simulation track to monitor, and the response; specify which programmatic events and attributes of said CBT track to monitor, and the response; specify action to take or custom code to execute in response to user interaction; specify decision and looping branching for determining program flow within said simulation track or other said CBT or said simulation tracks through use of programmatic method calls; call simulation programmatic methods to generate simulated malfunctions, warnings or other simulation actions; output said CBT track as a software code file.

13. The method of claim 10 wherein said graphical authoring tool is used to generate segment names; generate topic names; assign topics to segments thereby establishing a hierarchy between segments and topics; assign said simulation and CBT tracks to topics thereby establishing a hierarchy between topics and tracks; determine menu items; assign a segment sequence; assign a required segment sequence; assign a topic sequence within segments, assign a required topic sequence; assign a simulation track sequence and a CBT track sequence and assign a required said CBT track sequence and simulation track sequence within topics.

14. The method of claim 1 further comprising the step of:
generating a lesson structure for providing a navigable hierarchical grouping of said at least one simulation track and said at least one CBT track.

15. The method of claim 14 wherein said lesson structure comprises one or more high level segments, each of said one or more high level segments being expanded into one or more topics, and each of said one or more topics being expanded into one or more CBT or simulation tracks.

16. The method of claim 15 wherein said lesson structure is displayed as a hierarchal menu with an expandable node tree structure or with a non-expandable node tree structure.

17. The method of claim 1 further comprising the step of:
displaying said accessed simulation in a simulation window and said accessed multimedia information in a CBT window, said simulation window and said CBT window having a predetermined size, shape and/or location to allow sequential or simultaneous display of said multimedia information and said simulation.

18. The method of claim 17 wherein said CBT track, said CBT track page, and/or said simulation track create the following display options: a full screen CBT window; a full screen simulation window; or a simultaneous partial screen CBT window and partial screen simulation window.

19. The method of claim 17 wherein if said simulation track is displayed without a corresponding CBT track, said simulation track is displayed full screen.

20. The method of claim 1 further comprising the steps of:
if a forward button is activated and current display track is said simulation track, and this is not a last track of a lesson, displaying the next simulation or CBT track of said lesson structure;
if a forward button is activated and current display track is said simulation track, and this is a last track of a lesson, displaying a main menu or an exit lesson prompt;
if a forward button is activated and current display track is said CBT track, and this is not a last page of a CBT track, displaying the next CBT page;
if a forward button is activated and current display track is said CBT track, and this is a last page of said CBT track and this is a last track of a lesson, displaying a main menu or an exit lesson prompt;
if a forward button is activated and current display track is said CBT track, and this is a last page of said CBT track and this is not a last track of a lesson, displaying the next simulation or CBT track of said lesson structure;
if a back button is activated and current display track is said simulation track and is a first track of a lesson, displaying the current simulation track from the start of said current simulation track;
if a back button is activated and current display track is said simulation track and is not the first track of a lesson, executing logic in a back section of the previous simulation or CBT track of said lesson structure;
if a back button is activated and current display track is said CBT track and display is not on a first page of said CBT track, moving to the previous page in said current display CBT track;
if a back button is activated and current display track is said CBT track on a first page of said CBT track and is a first track of a lesson, displaying the current CBT track from the start of said current CBT track; and
if a back button is activated and current display track is said CBT track on a first page of said CBT track and is not a first track of a lesson, executing logic in a back section of the previous simulation or CBT track of said lesson structure;

21. The method of claim 1 wherein navigation of said accessed simulation and said accessed multimedia information is accomplished by user interaction with navigation controls, or by user interaction with said multimedia information or said simulation.

22. The method of claim 4 wherein said simulation responds to user interaction with multimedia information and said multimedia information responds to user interactions with said simulation and simulation events.

23. The method of claim 1 further comprising the step of:
selectively enabling and disabling navigation controls to enforce a required sequence and/or completion of specific simulation interaction within a lesson comprising an accessed said simulation track and/or accessed CBT track, said navigation controls comprising forward, back, replay, menu and exit controls.

24. The method of claim 23 further comprising the step of:
selectively enabling or disabling said navigation controls based on completion results of said simulation track or simulation interaction.

25. The method of claim 1 further comprising the step of:
storing data of one or more preferences of a user of said simulation, skills of said user, needs of said user and preferences of said user in a student profile, using said stored data to customize the presentation of content from said at least one simulation track or said at least one CBT track.

26. The method of claim 1 comprising the construction and display of content from a dynamic syllabus comprising of one or more, or any combination of the following steps:
an automated addition of said at least one simulation track or said at least one CBT track to a remediation track queue if a user has not mastered skills of said accessed least one simulation track or said at least one CBT track; using student profile skills, needs or preferences information, or in combination with user performance data to determine at least one remedial simulation track or remedial CBT track to be added to a remediation track queue;
manually assigning remedial simulation or CBT tracks to student users based on instructor evaluation of student performance; and
prior to display and completion of said simulation and CBT tracks, automated granting of credit to said at least one simulation track or at least one CBT track based on a satisfactory evaluation of previous simulation track and/or CBT track performance, and/or student profile skills; and
presenting said at least one simulation track or at least one CBT track based on previous simulation track performance and/or CBT track performance by a user, and/or student profile skills, needs or preferences by a user.

27. The method of claim 1 further comprising the step of:
mapping said at least one simulation track or at least one CBT track to a hierarchal task or objective list by creating a database cross-referencing the initialization information of said at least one simulation track and said at least one CBT track with identifiers of tasks, objectives or other hierarchal arrangement of information.

28. The method of claim 27 further comprising the step of:
mapping lesson topics to said simulation track or said CBT track.

29. The method of claim 1 wherein said simulation track initialization information is created using data from initialization snapshots output from the simulation at timed or logical intervals, said simulation track initialization information including type, location and heading of one or more controlled entities, entity status information, global environment information and location, type, heading and status information for all other entities present in the simulation.

30. The method of claim 1 wherein said simulation track initialization information is generated by manually creating a series of simulation track initialization files, said simulation track initialization information including type, location and heading of one or more controlled entities, entity status information, global environment information and type, location, heading and status information for all other entities present in the simulation.

31. A system of integrating simulation and multimedia information comprising:
means for determining at least one simulation track, said simulation track comprising simulation track initialization information comprising a series of predefined initialization points to delineate a reference to said simulation;
means for determining at least one computer based training (CBT) track, said CBT track comprising CBT track initialization information comprising a series of predefined attributes to delineate a reference to said multimedia information;
means for navigating and accessing said simulation using said simulation track; and
means navigating and accessing said multimedia information using said CBT track.

32. The system of claim 31 further comprising the steps of:
means for initializing said simulation to a known simulation start point using said simulation track initialization information to provide navigation and access of said simulation using said simulation track; and
means for initializing CBT display window to a known start point using said CBT track initialization information to provide navigation and access of said multimedia information.

33. The system of claim 32 wherein said simulation track initialization information comprises one or more of the following parameters selected from the group consisting of type, location and heading of one or more controlled entities, entity status information, global environment information and type, location, heading and status information for all other entities present in the simulation.

34. The system of claim 31 wherein said simulation track further comprises a simulation track body comprising attributes, programmatic methods, and the ability to raise programmatic events and said CBT track further comprises a CBT track body comprising attributes, programmatic methods, and the ability to raise programmatic events and further comprising:
means for communicating at least one said attribute of said simulation track and/or at least one said attribute of said CBT track between said simulation track and said CBT track, along with use of said track programmatic methods and raising of said programmatic events thereby providing synchronization and integrated display of said simulation and said multimedia information.

35. The system of claim 31 wherein said simulation track body comprises attributes, programmatic methods and programmatic events that generate functionality for one or more tasks selected from the group consisting of: monitoring and responding to simulation programmatic events, attributes and other data output; monitoring and responding to said CBT track programmatic events and attributes; monitoring and responding to said simulation track programmatic events and attributes; responding to user interactions; displaying text; activating text to speech engine; engaging camera moves; highlighting control panels or buttons; changing values of simulation attributes; changing values of said simulation track attributes; changing values of said CBT track attributes; specifying enabled or disabled state of navigation controls; looping, branching or jumping to different program flows within a current said simulation track or another said CBT track or simulation track; providing demonstrations of and coaching on, instrument operation, procedures, and maneuvers; evaluating user instrument operation, performance of procedures or maneuvers, storing data on user performance, skills, needs and preferences, exposing simulation track programmatic methods that can be called by said at least one CBT track or at least one simulation track or the simulation to trigger execution of program code within said at least one simulation track; raising simulation track programmatic events to which other of said at least one CBT track or at least one simulation track or the simulation can respond; calling simulation programmatic methods to generate simulated malfunctions, warnings or other simulation actions.

36. The system of claim 31 wherein said CBT track initialization information comprises one or more of the following parameters: a unique track identifier; initialization data for CBT track attributes which include a total number of pages in the track, and initialization data for each page including: filename/s or database location of static or interactive content to be displayed; content formatting instructions specifying details of size and/or location of content on page, ID of associated simulation track; size of CBT window, type of CBT window, and location of CBT window; attributes to specify an initial enabled or disabled state of navigation controls and; CBT track initialization data which include the start state of any attributes of said CBT track that have been added to said CBT track by a lesson creator.

37. The system of claim 31 wherein said CBT track body comprises attributes, programmatic methods and programmatic events that generate functionality for one or more tasks selected from the group consisting of: display of one or more pages of multimedia information; monitoring and responding to simulation programmatic events, attributes and other data output; monitoring and responding to said CBT track programmatic events and attributes; monitoring and responding to said simulation track programmatic events and attributes; responding to user interactions, displaying multimedia information based on user interactions; changing values of simulation attributes; changing values of said simulation track attributes; changing values of said CBT track attributes; specifying enabled or disabled state of navigation controls; looping, branching or jumping to different program flows within current said CBT track or another said CBT track or simulation track; providing demonstrations of and coaching on, instrument operation, procedures, or maneuvers; evaluating user knowledge, skills and performance; storing data on user knowledge, performance, skills, needs and preferences, exposing CBT track programmatic methods that can be called by said at least one CBT track or at least one simulation track or the simulation to trigger execution of program code within said at least one CBT track; raising CBT track programmatic events to which other of said at least one CBT track or said at least one simulation track or the simulation can respond; calling simulation track programmatic methods to generate simulated malfunctions, warnings or other simulation actions.

38. The system of claim 31 wherein said simulation track further comprises simulation track metadata said simulation track metadata comprising one or more parameters selected from the group consisting of identification number of said simulation track; title of said simulation track, subject keywords, identification numbers of other simulation tracks or said CBT tracks referenced by said simulation track, and identification number of training tasks or objectives that are taught by said simulation track.

39. The system of claim 31 wherein said CBT track further comprises CBT track metadata, said CBT track metadata comprising one or more parameters selected from the group consisting of identification number of said CBT track, title of said CBT track, subject keywords, identification numbers of other said simulation tracks or CBT tracks referenced by said or CBT track and identification number of training tasks or objectives that are taught by said CBT track.

40. The system of claim 31 wherein said at least one CBT track and said at least one simulation track are generated with a graphical authoring tool.

41. The system of claim 40 wherein said graphical authoring tool is used to provide one or more of the following: assign track identification, title, keywords, and metadata attributes to the simulation track; select a simulation snapshot file to be converted into a simulation track initialization file; create a new or edit an existing simulation track initialization file; specify one or more simulation track attributes, and private/public programmatic methods and programmatic events that can be raised; specify which programmatic events and attributes of simulation to monitor, and the response; specify which programmatic events and attributes of said simulation track to monitor, and the response; specify which programmatic events and attributes of said CBT track to monitor, and the response; specify actions to take or custom code to execute in response to user interaction; display text; activate text to speech engine; engage camera moves; highlight control panels or buttons; specify enabled or disabled state of navigation controls; specify decision and looping branching for determining program flow within said simulation track or other said CBT tracks or said simulation tracks through use of programmatic method calls; call simulation programmatic methods to generate simulated malfunctions, warnings or other simulation actions; output said simulation track as a software code file.

42. The system of claim 40 wherein said graphical authoring tool is used to provide one or more of the following: assign track identification, title, keywords, and metadata attributes to said CBT track; add blank pages to said CBT track; specify size, type, and location of a CBT window for each page of said CBT track; add and format said multimedia information and/or resources for each said CBT track or a CBT track page of said CBT track; specify navigation controls to be enabled or disabled at page start-up and in response to interactions; specify a simulation track identification reference for said CBT track pages of said CBT track that are paired with said at least one simulation track; specify one or more of said attributes of said CBT track, programmatic events that can be raised and private/public programmatic methods; specify which programmatic events and attributes of simulation to monitor, and the response; specify which programmatic events and attributes of said simulation track to monitor, and the response; specify which programmatic events and attributes of said CBT track to monitor, and the response; specify action to take or custom code to execute in response to user interaction; specify decision and looping branching for determining program flow within said simulation track or other said CBT or said simulation tracks through use of programmatic method calls; call simulation programmatic methods to generate simulated malfunctions, warnings or other simulation actions; output said CBT track as a software code file.

43. The system of claim 40 wherein said graphical authoring tool is used to generate segment names; generate topic names; assign topics to segments thereby establishing a hierarchy between segments and topics; assign said simulation and CBT tracks to topics thereby establishing a hierarchy between topics and tracks; determine menu items; assign a segment sequence; assign a required segment sequence; assign a topic sequence within segments, assign a required topic sequence; assign a simulation track sequence and a CBT track sequence and assign a required said CBT sequence and simulation track sequence within topics.

44. The system of claim 31 further comprising:
means for generating a lesson structure for providing a navigable hierarchical grouping of said at least one simulation track and said at least one CBT track.

45. The system of claim 44 wherein said lesson structure comprises one or more high level segments, each of said one or more high level segments being expanded into one or more topics, and each of said one or more topics being expanded into one or more CBT or simulation tracks.

46. The method of claim 45 wherein said lesson structure is displayed as a hierarchal menu with an expandable node tree structure or with a non-expandable node tree structure.

47. The system of claim 31 further comprising:
means for displaying said accessed simulation in a simulation window and said accessed multimedia information in a CBT window, said simulation window and said CBT window having a predetermined size, shape and/or location to allow sequential or simultaneous display of said multimedia information and said simulation.

48. The system of claim 47 wherein said CBT track, said CBT track page, and/or said simulation track create the following display options: a full screen CBT window; a full screen simulation window; or a simultaneous partial screen CBT window and partial screen simulation window.

49. The system of claim 47 wherein if said simulation track is displayed without a corresponding CBT track, said simulation track is displayed full screen.

50. The system of claim 31 further comprising:
if a forward button is activated and current display track is said simulation track, and this is not a last track of a lesson, means for displaying the next simulation or CBT track of said lesson structure;
if a forward button is activated and current display track is said simulation track, and this is a last track of a lesson, means for displaying a main menu or an exit lesson prompt;
if a forward button is activated and current display track is said CBT track, and this is not a last page of a CBT track, means for displaying the next CBT page;
if a forward button is activated and current display track is said CBT track, and this is a last page of said CBT track and this is a last track of a lesson, means for displaying a main menu or an exit lesson prompt;
if a forward button is activated and current display track is said CBT track, and this is a last page of said CBT track and this is not a last track of a lesson, means for displaying the next simulation or CBT track of said lesson structure;
if a back button is activated and current display track is said simulation track and is a first track of a lesson, means for displaying the current simulation track from the start of said current simulation track;
if a back button is activated and current display track is said simulation track and is not the first track of a lesson, means for executing logic in a back section of the previous simulation or CBT track of said lesson structure;
if a back button is activated and current display track is said CBT track and display is not on a first page of said CBT track, means for moving to the previous page in said current display CBT track;
if a back button is activated and current display track is said CBT track on a first page of said CBT track and is a first track of a lesson, means for displaying the current CBT track from the start of said current CBT track; and
if a back button is activated and current display track is said CBT track on a first page of said CBT track and is not a first track of a lesson, means for executing logic in a back section of the previous simulation or CBT track of said lesson structure;

51. The system of claim 31 wherein navigation of said accessed simulation and said accessed multimedia information is accomplished by user interaction with navigation controls, or by user interaction with said multimedia information or said simulation.

52. The system of claim 34 wherein said simulation responds to user interaction with multimedia information and said multimedia information responds to user interactions with said simulation and simulation events.

53. The system of claim 31 further comprising:
means for selectively enabling and disabling navigation controls to enforce a required sequence and/or completion of specific simulation interaction within a lesson comprising an accessed said simulation track and/or accessed CBT track, said navigation controls comprising forward, back, replay, menu and exit controls.

54. The system of claim 53 further comprising:
means for selectively enabling or disabling said navigation controls based on completion results of said simulation track or simulation interaction.

55. The system of claim 31 further comprising:
means for storing data of one or more preferences of a user of said simulation, skills of said user, needs of said user and preferences of said user in a student profile, using said stored data to customize the presentation of content from at least one simulation track or said at least one CBT track.

56. The system of claim 31 comprising the construction and display of content from a dynamic syllabus comprising of one or more, or any combination of the following:
means for an automated addition of said at least one simulation track or said at least one CBT track to a remediation track queue if a user has not mastered skills of said accessed at least one simulation or at least one CBT track; using student profile skills, needs or preferences information, or in combination with user performance data to determine remedial simulation track or remedial CBT track to be added to a remediation track queue;
manually assigning remedial simulation or CBT tracks to student users based on instructor evaluation of student performance; and
means for prior to display and completion of said simulation and CBT tracks, automated granting of credit to said at least one simulation or at least one CBT track based on a satisfactory evaluation of previous simulation track and/or CBT track performance, and/or student profile skills; and
means for presenting said at least one simulation or at least one CBT track based on previous simulation track performance and/or CBT track performance by a user, and/or student profile skills, needs or preferences by a user.

57. The system of claim 31 further comprising:
means for mapping said at least one simulation track or at least one CBT track to a hierarchal task or objective list by creating a database cross-referencing the initialization information of said at least one simulation track and CBT tracks with identifiers of tasks, objectives or other hierarchal arrangement of information.

58. The system of claim 57 further comprising:
means for mapping lesson topics to said simulation track or said CBT track.

59. The system of claim 31 wherein said simulation track initialization information is created using data from initialization snapshots output from the simulation at timed or logical intervals, said simulation track initialization information including type, location and heading of one or more controlled entities, entity status information, global environment information and location, type, heading and status information for all other entities present in the simulation.

60. The system of claim 31 wherein said simulation track initialization information is generated by manually creating a series of simulation track initialization files, said simulation track initialization information including type, location and heading of one or more controlled entities, entity status information, global environment information and type, location, heading and status information for all other entities present in the simulation.

61. A computer program product comprising a computer useable medium having computer program logic recorded thereon for enabling a processor in a computer system to provide integration and navigation of simulation and multimedia information comprising:
means for determining at least one simulation track, said simulation track comprising simulation track initialization information comprising a series of predefined initialization points to delineate a reference to said simulation;
means for determining at least one computer based training (CBT) track, said CBT track comprising CBT track initialization information comprising a series of predefined attributes to delineate a reference to said multimedia information;
means for navigating and accessing said simulation using said simulation track; and
means for navigating and accessing said multimedia information using said CBT track.

62. The computer program product of claim 61 wherein said simulation track further comprises a simulation track body comprising attributes and programmatic methods, and the ability to raise programmatic events and said CBT track further comprises a CBT track body comprising attributes, programmatic methods, and the ability to raise programmatic events and further comprising the step of:
communicating at least one said attribute of said simulation track and/or at least one said attribute of said CBT track between said simulation track and said CBT track, along with use of said track programmatic methods and raising of said programmatic events thereby providing synchronization and integrated display of said simulation and said multimedia information.
